(19) United States
(12) Patent Application Publication
(10) Pub. No.: US 2021/0241605 A1
(43) Pub. Date: Aug. 5, 2021

(54) WEARABLE DEVICE AND SYSTEM FOR PERSONAL WELLBEING

(71) Applicant: BUZZ LABS, INC., Beverly Hills, CA (US)

(72) Inventors: Jennifer LANG, Beverly Hills, CA (US); Robert Gerald KRAMER, Santa Monica, CA (US)

(21) Appl. No.: 17/053,920

(22) PCT Filed: May 7, 2019
(86) PCT No.: PCT/US2019/031147

§ 371 Date: Nov. 9, 2020

Related U.S. Application Data
(60) Provisional application No. 62/668,164, filed on May 7, 2018.

(51) Int. Cl. G08B 25/01; G08B 21/02

(52) U.S. Cl. CPC G08B 25/016; G08B 21/02

(57) ABSTRACT

Systems and methods for enhancing safety in social (e.g., dating) situations. These systems may provide passive intoxicant monitoring, personal wellbeing improvement, and methods for safe social and intimate interaction to enhance consensual engagement. Passive intoxicant monitoring, such as blood alcohol level may include real-time feedback regarding the user's cognitive capacity and specifically the user's capacity to engage in sexual activity. These devices, systems and methods may also improve user self-awareness.

### CROSS REFERENCE TO RELATED APPLICATIONS

This application claims priority to U.S. Provisional Application No. 62/668,164 (titled “WEARABLE BIOSENSOR AND COMMUNICATION SYSTEM TO AID IN DETERMINING THE COGNITIVE CAPACITY TO PARTICIPATION IN A SEXUAL ACTIVITY AND IMPROVE SAFETY FROM SEXUAL ASSAULT”), filed on May 7, 2018, the disclosure of which is herein incorporated by reference in its entirety.

### INCORPORATION BY REFERENCE

All publications and patent applications mentioned in this specification are herein incorporated by reference in their entirety to the same extent as if each individual publication or patent application was specifically and individually indicated to be incorporated by reference.

### FIELD

Described herein are apparatuses (e.g., systems, devices, etc.) and methods for enhancing safety in social (e.g., dating) situations. These systems may provide passive intoxicant monitoring, personal wellbeing improvement, and methods for safe social and intimate interaction to enhance consensual engagement.

### BACKGROUND

Personal safety devices have been available to provide alerts or to call emergency personnel in situations where a person living alone may be vulnerable, such as incapacitating falls due to seizures, diabetic blood sugar extremes, stroke, and the like. Simple alarms such as battery powered alarms for solo travelers have also been available. However, more proactive and engaged personal wellbeing systems and methods are needed to address complex social situations where individuals may find themselves vulnerable to unwanted substances or sexual interactions. Socially interactive systems and methods are described herein to provide passive intoxicant monitoring, personal wellbeing improvement, and methods for safe social and intimate interaction to enhance consensual engagement. The passive intoxicant monitoring, such as blood alcohol level is paired with a software algorithm to provide real-time feedback regarding the individual's cognitive capacity to engage in sexual activity. Improvements in self-awareness may be obtained through use of the devices, systems and methods. These systems and methods may further be gamified to encourage participation, particularly within college-age and post-graduate cohorts of adults, to become part of a social network with a shared expectation of responsibility towards each other. The social compact between users (e.g., wearers of the wearable device) encourages honest and transparent communications to ensure consensual sexual activity. Wearers connect friend-to-friend to build an empathic, equitable, and open network of engaged participants that can deter bad actors and prevent non-consensual activities, such as sexual assault.

Sexual assault is epidemic, with peak incidence during the young adult years. Many educational campaigns and programs have been initiated in the United States and globally, over the past decades, to attempt to reduce the incidence of sexual assault. Most efforts have failed. Intoxicating substances, most ubiquitously alcohol, are involved in the majority of sexual assaults. The intoxicants may have been consumed by the perpetrator, the victim or both. The presence of intoxicating substances can inhibit the cognitive function of both the perpetrator and the victim. For the perpetrator, these substances may cause them to perceive his/her victim as more willing to engage in sexual contact than the victim, in fact, is. For the victim, these substances may inhibit or impair her/his ability to verbally communicate their consent or non-consent for the sexual contact. Additionally, the gross motor function of the victim may be so affected by the intoxicant that s/he cannot physically communicate the lack of consent.

When cognitive capacity is impaired due to an intoxicating substance, an individual's level of consciousness and/or ability to form new memories may be impacted. In this state, it is impossible to give active affirmative consent to a sexual act with another individual. The majority of sexual assaults involve voluntary incapacitation on the part of the victim, knowingly consuming an intoxicating substance to the point where they lack the cognitive ability to give sexual consent.

There has been no way of determining, in a real time social setting whether a potential sexual partner is under the influence of an intoxicating substance, approaching or exceeding the point where she/he lacks the capacity to give consent to sexual activity. There is an urgent need in the field for biosensors and systems that can determine the capacity for sexual consent and provide real time feedback to an individual to enhance her/his ability to make decisions around engagement in sexual activities.

### SUMMARY OF THE DISCLOSURE

The apparatuses (e.g., devices and systems) and methods described herein may incorporate, enhance and improve upon currently existing biosensors, by collecting biomarker data and integrating the data to provide real time feedback and other notifications to a user and to a curated selection of user-specified associates (trusted companions, friends, family, colleagues, dating partners, etc.). The real time feedback may improve the user's ability to make informed decisions regarding sexual consent, amongst other goals. These apparatuses and methods may permit extension of real-time feedback that is provided solely to the individual to include notifications to trusted companions selected by the user to enhance safety and well-being, particularly in a peer-to-peer network.

The system and methods for enhanced personal wellbeing described herein include a wearable device including a biosensor and a communications hub, and a non-transitory computer-readable medium in which a program is stored for causing a computer to perform a method for monitoring/controlling at least one of Blood Intoxicant Level (BIL), acceptable interaction levels, a trusted companion network notification, and self-awareness monitoring. The non-transitory computer-readable medium may be a software application hosted on a mobile device (e.g., smartphone, tablet, wearable electronics, etc.) and/or optionally may also be web-based.

The system is designed for use in social settings. In one variation, a system includes a wearable device that contains a biosensor, a display, a vibrational motor, a battery and the capacity to transmit information to an associated software application and receive information from another user's compatible wearable device. In some variations, the wearable device may be a bracelet. The system is further configured to send and receive messages to confidants within the trusted companion network designated by the wearer of the device.

In some variations, the software application may receive data from the wearable device of the user passively, without any need for the wearer to open the application or manually input data. Messages and alerts from the software application may likewise be sent to members of the trusted companion network without any action initiated by the user, other than by wearing the wearable device. The system may maintain the fun and romantic aspects of voluntary sexual play while integrating the concept of awareness that beyond a certain level of cognitive impairment the activity can no longer be viewed as voluntary.

For example, a system may include: a wearable device and a non-transitory computer-readable medium in which a program is stored for causing a processor to perform a method. The wearable device may include: a blood intoxicant level (BIL) sensor; an attaching linker, wherein the attaching linker secures the BIL sensor in proximity to a region of skin of a user for sensing the BIL; and a communications hub configured to send/receive information to and from the wearable device. The method performed by the non-transitory computer-readable medium may include: (optionally) receiving, from the user, a plurality of contacts, wherein each contact corresponds to a trusted individual; (optionally) forming one or more sets of contacts from the plurality of contacts; receiving or identifying a contact set from the one or more sets of contacts; triggering a first user alert in the wearable device when data received by the BIL sensor indicates that the user has passed a first intoxicant threshold; and transmitting a trusted individual alert and a second user alert when the data received by the BIL sensor indicates that the user has passed a second intoxicant threshold, wherein the trusted individual alert is transmitted to all of the trusted individuals in the selected contact set, further wherein the trusted individual alert comprises an indication that the user has exceeded the second intoxicant threshold and a location of the user; and wherein the second user alert is a persistent indicator on the wearable device.

A system may comprise: a wearable device, the device comprising: a blood intoxicant level (BIL) sensor; an attaching linker, wherein the attaching linker secures the BIL sensor in proximity to a region of skin of a user for sensing the BIL; and a communications hub configured to send/receive information to and from the wearable device; and a non-transitory computer-readable medium in which a program is stored for causing a processor to perform a method comprising: receiving, from the user, a plurality of contacts, wherein each contact corresponds to a trusted individual; forming one or more sets of contacts from the plurality of contacts; identify a contact set from the one or more sets of contacts; confirming with each trusted individual in the contact set that they agree to monitor the user; monitoring the BIL sensor to determine a level of intoxicant in the user's body; triggering a first user alert in the wearable device until a dismiss command is received from the user when data received by the BIL sensor indicates that the user has passed a first intoxicant threshold; and transmitting a trusted individual alert and a second user alert when the data received by the BIL sensor indicates that the user has passed a second intoxicant threshold, wherein the trusted individual alert is transmitted to all of the trusted individuals in the contact set and comprises an indication that the user has exceeded the second intoxicant threshold and a location of the user; and wherein the second user alert is a persistent indicator on the wearable device.

A system may comprise: a wearable device, the device comprising: a blood intoxicant level (BIL) sensor; an attaching linker, wherein the attaching linker secures the BIL sensor in proximity to a region of skin of a user for sensing the BIL; and a communications hub configured to send/receive information to and from the wearable device; and a non-transitory computer-readable medium in which a program is stored for causing a processor to perform a method comprising: receiving, from the user, a plurality of contacts, wherein each contact corresponds to a trusted individual; forming one or more sets of contacts from the plurality of contacts; identify a contact set from the one or more sets of contacts; confirming with each trusted individual in the contact set that they agree to monitor the user; monitoring the BIL sensor to determine a level of intoxicant in the user's body; triggering a first visible and tactile user alert in the wearable device when data received by the BIL sensor indicates that the user has passed a first intoxicant threshold; and transmitting a trusted individual alert and a second visible user alert when the data received by the BIL sensor indicates that the user has passed a second intoxicant threshold, wherein the trusted individual alert is transmitted to all of the trusted individuals in the contact set and comprises an indication that the user has exceeded the second intoxicant threshold and a location of the user; and wherein the second user alert is a persistent indicator on the wearable device.

In any of these systems, the non-transitory computer-readable medium may be configured to confirm with each trusted individual in the selected contact set that they agree to monitor the user for a first period of time. The step of receiving, from the user, a plurality of contacts, wherein each contact corresponds to a trusted individual may be done manually or automatically and may be done, e.g., in a user interface. In some variations, as described below, contacts may be added (or removed) by locally pairing devices with another user (e.g., a friend, colleague, date, etc.). The step of forming one or more sets of contacts from the plurality of contacts may be done manually or automatically. The different sets may correspond to different geographical and/or social regions. For example, a user may select a set of contacts based on trusted individuals that are with their local social group (home, work, school, etc.). A user may select a contact set before any event (e.g., party, etc.). Contact sets may be adjusted (added to/subtracted from) based on user selection, and/or automatically by the trusted individual opting in or out. Contact sets may be any appropriate size (e.g., 1, 2, 3, 4, 5, 6, 7, 8, 9, 10, etc.). Trusted individuals may be added to the contact set later (including during use) and/or may be removed from the selected contact set. For example, a trusted individual that is also wearing a device to monitor BIL may be removed automatically if their BIL exceed a removal threshold, if they go out of a proximity/geographic range, after a predetermined time, and/or they may voluntarily remove themselves.

In any of these variations, the apparatus may select the contact set prior to engaging in an activity.

In general, the apparatus may periodically, intermittently, or continuously monitor the BIL sensor and to determine a level of intoxicant in the user's body.

The thresholds may be user adjustable. For example, the system may receive, from the user, an adjustment to one or more of a first intoxicant threshold and a second intoxicant threshold. For example, the first intoxicant threshold may only be adjusted down from a first level and the second intoxicant threshold may only be adjusted down from a second level. In some variations the level may be a blood alcohol level.

In any of these systems and methods described herein, the first user alert may comprise a visual indicator comprising a first light display (e.g. illuminating a color, such as yellow, to indicate a mildly impaired state). Alternatively or additionally, the first user alert may comprise a vibration of the wearable device. The first user alert may last until dismissed by the user, e.g., by activating a control (button, dial, knob, touch point, etc.), such as by tapping the device (triggering a vibration and/or contact sensor). Thus, the first user alert may be configured to continue until a dismiss command is received from the user. For example, the first user alert and the second user alert may comprise a set of signals, each having a spectrally distinct wavelength from about 450 nm to about 700 nm. The set of signals may comprise a green or blue signal, a yellow signal and a red signal.

The second user alert may comprises a visual indicator such as a second light display (e.g., illuminating a color, such as red, to indicate a compromised, impaired or diminished cognitive state, in which the user may lack the ability to consent (e.g., to sexual activity). The second alter may be visible to the user and to a nearby person (e.g., dating partner, etc.). The trusted individual alert may be transmitted (by the system, either directly, via text message, SMS, or otherwise) to a trusted individual in the active contact set for the user. All of the trusted individuals may receive a notification in the active contact set, or a hierarchy of trusted individuals may receive the trusted individual alert; for example, one or more of the trusted individuals may receive the trusted individual alert and if they fail to acknowledge or respond (e.g., to the SMS, etc.) the trusted individual alert may be sent to one or more additional members of the contact set. In any event one or more persons in the contact set does not acknowledge the trusted individual alert within a predetermined time period, the trusted individual alert may repeat (e.g., every 3 minutes, 4 minutes, 5 minutes, 7 minutes, 10 minutes, 12 minutes, 13 minutes, 15 minutes, etc.). The trusted individual alert may include a geographic location, such as an address, map, etc.

In any of these variations, the BIL sensor may be configured to detect blood alcohol level. Alternatively or additionally, the BIL sensor may be configured to detect one a cannabinoid intoxicant level and/or incapacitating drug level, e.g. gamma hydroxybutyrate (GHB). In general, the BIL sensor may be a transdermal sensor.

The attaching linker may attach the BIL sensor in proximity to skin at a region of a wrist, a neck, a finger, an ear, an arm or a leg. For example, the BIL sensor and the communications hub may be disposed upon the attaching linker. In some variations, the attaching linker is a wristband. The communications hub may comprise one or more of: a display and a vibrational motor. The communications hub may comprise a sensor for a pairing signal from a second wearable device.

In some variations, the communications hub may comprise a processor, which is configured to do one or more of: send/receive information to/from the BIL sensor; initiate the at least one visible signal; and/or activate a vibrational motor. The communications hub may comprise a user input interface comprising one of: a toggle to a preferred mode of “OK” signal; a toggle to an “uncomfortable”/“no consent” mode; an initiation of a message to a third party; and a memory tag.

Also described herein are methods for assisting in a user's personal safety, which may be performed by any of the systems described herein. For example, a method may comprise: receiving, from the user, a plurality of contacts, wherein each contact corresponds to a trusted individual; forming one or more sets of contacts from the plurality of contacts; identify a contact set from the one or more sets of contacts; triggering a first user alert in the wearable device when data received by a wearable blood intoxication level (BIL) sensor indicates that the user has passed a first intoxicant threshold; and transmitting a trusted individual alert and a second user alert when the data received by the BIL sensor indicates that the user has passed a second intoxicant threshold, wherein the trusted individual alert is transmitted to all of the trusted individuals in the selected contact set, further wherein the trusted individual alert comprises an indication that the user has exceeded the second intoxicant threshold and a location of the user; and wherein the second user alert is a persistent indicator on the wearable device.

For example, a method for assisting in a user's personal safety may include: receiving, from the user, a plurality of contacts, wherein each contact corresponds to a trusted individual; forming one or more sets of contacts from the plurality of contacts; identify a contact set from the one or more sets of contacts; confirming with each trusted individual in the contact set that they agree to monitor the user; monitoring the BIL sensor to determine a level of intoxicant in the user's body; triggering a first user alert in the wearable device until a dismiss command is received from the user when data received by the BIL sensor indicates that the user has passed a first intoxicant threshold; and transmitting a trusted individual alert and a second user alert when the data received by the BIL sensor indicates that the user has passed a second intoxicant threshold, wherein the trusted individual alert is transmitted to all of the trusted individuals in the contact set and comprises an indication that the user has exceeded the second intoxicant threshold and a location of the user; and wherein the second user alert is a persistent indicator on the wearable device.

A method for assisting in a user's personal safety, the method comprising: receiving, from the user, a plurality of contacts, wherein each contact corresponds to a trusted individual; forming one or more sets of contacts from the plurality of contacts; identify a contact set from the one or more sets of contacts; confirming with each trusted individual in the contact set that they agree to monitor the user; monitoring the BIL sensor to determine a level of intoxicant in the user's body; triggering a first visible and tactile user alert in the wearable device when data received by the BIL sensor indicates that the user has passed a first intoxicant threshold; and transmitting a trusted individual alert and a second visible user alert when the data received by the BIL sensor indicates that the user has passed a second intoxicant threshold, wherein the trusted individual alert is transmitted to all of the trusted individuals in the contact set and comprises an indication that the user has exceeded the second intoxicant threshold and a location of the user; and wherein the second user alert is a persistent indicator on the wearable device.

Any of these methods may include confirming with each trusted individual in the selected contact set that they agree to monitor the user for a first period of time (e.g., 1 hour, 2 hours, 2.5 hours, 3 hours, 3.5 hours, 4 hours, 4.5 hours, 5 hours, 6 hours, 7 hours, 8 hours, 9 hours, etc.). Any of these methods may include selecting the contact set prior to engaging in an activity, as discussed above.

The methods and systems for performing them described herein may also include continuously monitoring the BIL sensor determining a level of intoxicant in the user's body. In some of these methods, the method may include receiving, from the user, an adjustment to one or more of a first intoxicant threshold and a second intoxicant threshold. In some variations, the first intoxicant threshold may only be adjusted down from a first level and the second intoxicant threshold may only be adjusted down from a second level.

The first user alert may include a visual indicator comprising a first light display (e.g., yellow light, indicating caution is necessary, slightly impaired). The first user alert may comprise a vibration of the wearable device. The first user alert may continue until a dismiss command is received from the user, as mentioned above. The second user alert may comprise a visual indicator comprising a second light display, such as a red light, indicating an inability to consent, e.g., to sexual activity.

Also described are systems for personal wellbeing that include: a wearable device for personal safety/wellbeing, comprising: a blood intoxicant level (BIL) sensor; a communications hub; and an attaching linker, wherein the attaching linker secures the BIL sensor in proximity to a region of skin of an individual for sensing a BIL; and a non-transitory computer-readable medium in which a program is stored for causing a processor to perform a method for: receiving data from the BIL sensor; and outputting one or more signals based on at least one of: acceptable interaction levels; a geographic location definition, a BIL limit; a trusted companion network status; and self-awareness monitoring.

The non-transitory computer-readable medium may be configured to select acceptable interaction levels prior to a specific event. The non-transitory computer-readable medium may be configured to select one or more individuals to form a trusted companion network. In some variations, the non-transitory computer-readable medium is configured to select a specific geographic location or a defined area around a specific geographic location. The non-transitory computer-readable medium may be configured to notify at least one member of the trusted companion network of the selected geographic location or defined area thereof. In some variations, the non-transitory computer-readable medium is configured to pre-select BIL limits. The non-transitory computer-readable medium may be configured to select at least one member of the trusted companion network and permitting notifications to/from the at least one member during a pre-selected period of time.

The non-transitory computer-readable medium may be configured to detect a pairing signal from a second wearable device of a second individual. The non-transitory computer-readable medium may be configured to pair the wearable device with the second wearable device to form a paired interaction. The non-transitory computer-readable medium may be configured to receive personal identifying information upon pairing. The non-transitory computer-readable medium may be configured to receive a BIL notification indicating the BIL of the wearer. The non-transitory computer-readable medium may be configured to send an alert to selected members of a trusted companion network.

The non-transitory computer-readable medium may be configured to send an alert indicating the BIL of the wearer to a paired second wearable device of a second individual. In some variations, the non-transitory computer-readable medium is configured to un-pair from a paired second wearable device. The non-transitory computer-readable medium may be configured to detect an acknowledgement signal from one or more other wearable devices.

The non-transitory computer-readable medium may be configured to join an in-situ social network with individuals wear the respective one or more other wearable devices. The non-transitory computer-readable medium may be configured to receive user input of one or more self-awareness goals and self-scoring markers.

The non-transitory computer-readable medium may be configured to deliver stress reduction messages when negative self-scoring markers are inputted. The non-transitory computer-readable medium may be configured to receiving a user's input of one or more individuals to receive notifications of the self-scoring markers. The non-transitory computer-readable medium may be configured to send notifications to and/or receiving notifications from one or more individuals requesting support. The non-transitory computer-readable medium may be configured to receive data from a processor of the wearable device, and sending a notification to a third party. In some variations the non-transitory computer-readable medium is configured to receive data from a user input interface on the communications hub to save a geographic location associated with a time stamp. The non-transitory computer-readable medium may be configured to annotate the geographic location associated with the time stamp with text and/or a photograph.

Also described herein are methods for pairing a first wearable device of a first wearer and a second wearable device of a second wearer, comprising; bringing the first and the second wearable device into a proximal location to each other, and exchanging electronic signals between the first and the second wearable device thereby pairing the first wearable device with the second wearable device; sending an alert from the first wearable device to the second wearable device, wherein sending the alert comprises sending information about a Blood Alcohol Content (BAC) level and/or the ability to consent.

Thus, in general, a wearable device for personal safety/wellbeing may be provided, including: a blood intoxicant level (BIL) sensor; a communications hub; and an attaching linker, where the attaching linker secures the BIL sensor in proximity to a region of skin of an individual for sensing the BIL. In some variations, the BIL sensor may detect cannabinoid intoxicant level or incapacitating drug level. In some variations, the BIL sensor may be a Blood Alcohol Content (BAC) sensor. The BIL sensor may be a transdermal sensor.

In some variations, the attaching linker may attach the BIL sensor in proximity to skin at a region of a wrist, a neck, a finger, an ear, an arm or a leg. In some variations, the BIL sensor and the communications hub may be disposed upon the attaching linker. The attaching linker may be a wristband.

In some variations, the communications hub may include a display and a vibrational motor. The display may include at least one visible signal. In some variations, the at least one visible signal may include a set of signals, each having a spectrally distinct wavelength from about 450 nm to about 700 nm. In some variations, the at least one visible signal having a set of signals may include a green or blue signal, a yellow signal and a red signal. In some variations, the at least one visible signal may include a range of visible intensities and/or patterns of signaling.

In some variations, the communications hub may include a sensor for a pairing signal from a second wearable device. In some variations, the communications hub may include a sensor for an acknowledgement signal from a second wearable device.

In some variations, the communications hub may include a processor, which is configured to: send/receive information to/from the BIL sensor; initiate the at least one visible signal; and/or initiate the vibrational motor. The processor may further include a messaging device configured to send information to a third party. The processor may further include a receiving device configured to receive information from a third party. In some variations, the processor may be configured to store the information from the third party for a pre-selected period of time. In some variations, the processor may be configured to store the information from the third party until deleted by a wearer of the wearable device. In some variations, the processor may include a geo-location device.

In some variations, the processor is for transmitting data to and receiving data from a non-transitory computer-readable medium in which a program is stored for causing a computer to perform a method for controlling at least one of acceptable interaction levels; a geographic location definition, a BIL limit; a trusted companion network status; and self-awareness monitoring.

In some variations, the communications hub may include a user input interface. The user input may include at least one of: a geographic location or a geographic range; a toggle to a preferred mode of “OK” signal; a toggle to an “uncomfortable”/“no consent” mode; initiation of a message to a third party; and, a memory tag. In some variations, the processor is for transmitting a signal to a second wearable device, based on the data received by the processor from the BIL sensor and the user input interface.

In some variations, the wearable device may include a stability detection subsystem including an accelerometer and a gyroscope. In some variations, the stability detection subsystem may be electronically connected to the processor of the communications hub and may not be physically connected to the communications hub. In some variations, the processor may be configured to receive data from the accelerometer from a gesture signifying consent from the wearable device. In some variations, the processor may be for receiving data from a second wearable device from a gesture signifying consent from a second wearable device. In some variations, the processor may be for receiving gyroscopic/accelerometer data and for initiating at least one of a visual alarm, a vibrational alarm and a message for help to a third party.

In some variations of the wearable device, the processor may further include a self-awareness monitor and the user input may be for at least one of self-monitoring stress levels and stress reduction interventions.

In some variations of the wearable device, the communications hub may include a battery.

In another aspect, a system for personal wellbeing is provided, including: a wearable device for personal safety/wellbeing, where the wearable device includes a blood intoxicant level (BIL) sensor; a communications hub; and an attaching linker, where the attaching linker secures the BIL sensor in proximity to a region of skin of an individual for sensing a BIL; and a non-transitory computer-readable medium in which a program is stored for causing a computer to perform a method for controlling at least one of acceptable interaction levels; a geographic location definition, a BIL limit; a trusted companion network status; and self-awareness monitoring.

In some variations of the system, the computer performed method may include selecting acceptable interaction levels prior to a specific event. The method may include selecting one or more individuals to form a trusted companion network.

In some variations of the system, the computer performed method may include selecting a specific geographic location or a defined area around a specific geographic location. The method may include notifying at least one member of the trusted companion network of the selected geographic location or defined area thereof.

In some variations of the system, the computer performed method may include pre-selecting BIL limits.

The computer performed method may include selecting at least one member of the trusted companion network and permitting notifications to/from the at least one member during a pre-selected period of time. In some variations, the method may further include detecting a pairing signal from a second wearable device of a second individual. The method further includes pairing the wearable device with the second wearable device to form a paired interaction. The method may further include receiving personal identifying information upon pairing.

In some variations of the system, the computer performed method may further include receiving a BIL notification indicating the BIL of the wearer. The BIL notification may include a change in the color of the display of the wearable device, a vibrational alert of the wearable device and/or a text alert to the associated mobile phone of the wearer. The method may further include sending an alert to selected members of a trusted companion network.

In some variations of the system, the computer performed method may further include sending an alert indicating the BIL of the wearer to a paired second wearable device of a second individual. The method further may further include unpairing from a paired second wearable device.

In some variations of the system, the computer performed method may further include detecting an acknowledgement signal from one or more other wearable devices. The method may further include joining an in-situ social network with individuals wear the respective one or more other wearable devices.

In some variations of the system, the computer performed method may further include inputting self-awareness goals and self-scoring markers. In some variations, the method may further include delivering stress reduction messages when negative self-scoring markers are inputted. The method may include inputting one or more individuals to receive notifications of the self-scoring markers. In some variations, the method may include sending notifications to and/or receiving notifications from one or more individuals requesting support.

In some variations of the system, the computer performed method may further include receiving data from a processor of the wearable device, and sending a notification to a third party.

In some variations, the computer performed method may further include receiving data from a user input interface on the communications hub to save a geographic location associated with a time stamp. The method may further include annotating the geographic location associated with the time stamp with text and/or a photograph.

In another aspect, a method for blood alcohol content (BAC) monitoring is provided, including: analyzing a BAC level of an individual; and alerting the individual in real time when a pre-selected threshold of the BAC level is reached. Analyzing the BAC level may be performed passively. In some variations, analyzing the BAC level may be performed transdermally. Analyzing the BAC level may be performed substantially in real time. In some variations, analyzing the BAC level may be performed continuously. In some variations, analyzing the BAC level may be performed intermittently.

In some variations of the method, alerting the individual may be performed passively. Alerting the individual may be performed substantially in real time. In some variations of the method, alerting the individual includes illuminating a visible signal on a display of a wearable device of the individual. The wearable device of the individual may receive information about the BAC level electronically. Alerting the individual may include sending a message to an associated mobile phone of the individual. Sending the message to the associated mobile phone of the individual may include at least one of a BAC level, a graphic of BAC level over time, a warning to slow or stop alcohol composition, a warning of impaired operation of a motor vehicle, or a warning of legal incapacity of consent. In some variations of the method, sending a message may further include at least one of a link to a ride service or a link to emergency personnel. In some variations of the method, alerting may include at least one of vibrating a wearable device of the individual or causing a vibration on an associated mobile phone of the individual.

In some variations of the method, alerting may further include alerting a pre-selected second person. Alerting the pre-selected second person may be performed passively. Alerting the pre-selected second person may be performed in real time or substantially in real time. Alerting the pre-selected second person may include at least one of texting, sending an email or causing a vibration of a mobile phone of the second person. In some variations, texting or sending an email may include information including at least one of a location of the individual or a BAC level of the individual.

In some variations of the method, alerting may further include alerting further a person wearing a second wearable device. The second wearable device of the person may receive information about the BAC level of the individual electronically. In some variations, the information may include a notification of lack of cognitive ability to consent. In some variations, alerting the person wearing the second wearable device may include causing the second wearable device to vibrate. Alerting the person wearing the second wearable device may be performed passively. Alerting the person wearing the second wearable device may be performed in real time or substantially real time.

In some variations, the method including analyzing and alerting may be performed automatically. In some variations, the method including automatically analyzing and automatically alerting may be performed by a computer. The computer may include a non-transitory program including instructions for performing the method.

In another aspect, a method for pairing a first wearable device of a first wearer and a second wearable device of a second wearer is provided, where the method includes bringing the first and the second wearable device into a proximal location to each other, and exchanging electronic signals between the first and the second wearable device thereby pairing the first wearable device with the second wearable device. In some variations, exchanging electronic signals may be performed passively. Exchanging electronic signals may be performed in real time or substantially in real time. Bringing the first and second wearable device into a proximal location to each other may include touching the first and the second wearable device to each other. Bringing the first and second wearable device into the proximal location to each other may include bringing the first and second wearable device into a pre-defined orientation with each other. Bringing the first and second wearable device into the proximal location may include maintaining the first and the second wearable device in the proximal location for a pre-defined period of time. In some variations, the pre-defined period of time may be from about 2 sec to about 5 sec. In some variations, exchanging electronic signals between the first and second wearable device may further include exchanging personal identifying information.

In some variations, the method may further include sending an alert from the first wearable device to the second wearable device. Sending the alert may include sending information about a Blood Alcohol Content (BAC) level of the first wearer. Sending the alert from the first wearable device to the second wearable device may include causing vibration of the second wearable device. Sending the alert may include sending a warning of a lack of cognitive ability of the first wearer for consent. In some variations, sending the alert may be performed passively.

In some variations, sending the alert may be performed actively by the first wearer. Sending the alert actively by the first wearer may include no information about BAC. Sending the alert actively by the first wearer may alert the second wearer of a lack of consent.

In some variations, exchanging the electronic signals between the first and the second wearable device thereby pairing the first wearable device with the second wearable device may be performed automatically.

In some variations, the method may further include actively unpairing the first wearable device of the first wearer from the second wearable device of the second wearer. Actively unpairing may include performing an unpairing gesture by the first wearer, where performing the unpairing gesture includes sending an electronic signal to the second wearable device, thereby disconnecting the second wearable device from the first wearable device. Disconnecting the second wearable device from the first wearable device may further include deleting personal identifying information sent between the first and the second wearable device.

In some variations, the method for pairing a first wearable device of a first wearer and a second wearable device of a second wearer may be performed automatically. In some variations, the method for pairing a first wearable device of a first wearer and a second wearable device of a second wearer may be performed by a computer, and further, optionally, the computer may include non-transitory instructions to perform the method.

### BRIEF DESCRIPTION OF THE DRAWINGS

The novel features of the invention are set forth with particularity in the claims that follow. A better understanding of the features and advantages of the present invention will be obtained by reference to the following detailed description that sets forth illustrative embodiments, in which the principles of the invention are utilized, and the accompanying drawings of which:

FIG. 1A is a graphical representation of one scenario of increasing physical intimacy according to an embodiment of the disclosure.

FIG. 1B is a graphical representation of another scenario of increasing physical intimacy according to an embodiment of the disclosure.

FIG. 1C is a graphical representation of another scenario of increasing physical intimacy according to an embodiment of the disclosure.

FIG. 1D is a graphical representation of yet another scenario of increasing physical intimacy according to an embodiment of the disclosure.

FIG. 1E is a graphical representation of some periods of time where a wearable device system, and methods of use thereof, may contribute to mutually agreeable increases of physical intimacy according to one embodiment of the disclosure.

FIG. 2 is a schematic representation of a system according to some embodiments of the disclosure.

FIGS. 3A-3B are graphical representations of a BIL sensor incorporated within a wearable device according to some embodiments of the disclosure.

FIGS. 3C-3E are graphical representations of the BIL sensor included in a wearable device system according to some embodiments of the disclosure.

FIGS. 4A-4C are graphical representations of a communications hub of a wearable device according to some embodiments of the disclosure.

FIG. 5 is a graphical representation of two states of a wearable device according to an embodiment of the disclosure.

FIGS. 6A-6D are graphical representations of a wearable device having multiple levels of alerts according to an embodiment of the disclosure.

FIGS. 7A-7D are graphical representations of methods of acknowledging and pairing according to some embodiments of the disclosure.

FIG. 8 is a graphical representation of other methods of acknowledging and pairing according to some embodiments of the disclosure.

FIGS. 9A-9E are graphical representations of methods of user input, BIL passive and active monitoring including notifying according to some embodiments of the disclosure.

FIG. 10 is a graphical representation of a method of actively implementing notifications, alerts and/or interventions according to an embodiment of the disclosure.

FIGS. 11A-11B are graphical representations of methods of actively implementing notifications, alerts and/or interventions according to some embodiments of the disclosure.

FIGS. 12A-12D are graphical representations of methods for mutually agreeing to increased intimacy according to some embodiments of the disclosure.

FIGS. 13A-13C are graphical representations of methods for creating memory markers according to some embodiments of the disclosure.

FIG. 14 is a graphical representation of a method for increasing personal wellbeing using the wearable device and system according to some embodiments of the disclosure.

FIGS. 15A-15B are graphical representations of a method for increasing personal wellbeing according to some embodiments of the disclosure.

### DETAILED DESCRIPTION

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Terminology used herein is for the purpose of describing particular embodiments only and is not intended to be limiting of the invention. For example, as used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be abbreviated as “/”.

Spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

Although the terms “first” and “second” may be used herein to describe various features/elements (including steps), these features/elements should not be limited by these terms, unless the context indicates otherwise. These terms may be used to distinguish one feature/element from another feature/element. Thus, a first feature/element discussed below could be termed a second feature/element, and similarly, a second feature/element discussed below could be termed a first feature/element without departing from the teachings of the present invention.

Throughout this specification and the claims which follow, unless the context requires otherwise, the word “comprise”, and variations such as “comprises” and “comprising” means various components can be co-jointly employed in the methods and articles (e.g., compositions and apparatuses including device and methods). For example, the term “comprising” will be understood to imply the inclusion of any stated elements or steps but not the exclusion of any other elements or steps.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical values given herein should also be understood to include about or approximately that value, unless the context indicates otherwise. For example, if the value “10” is disclosed, then “about 10” is also disclosed. Any numerical range recited herein is intended to include all sub-ranges subsumed therein. It is also understood that when a value is disclosed that “less than or equal to” the value, “greater than or equal to the value” and possible ranges between values are also disclosed, as appropriately understood by the skilled artisan. For example, if the value “X” is disclosed the “less than or equal to X” as well as “greater than or equal to X” (e.g., where X is a numerical value) is also disclosed. It is also understood that the throughout the application, data is provided in a number of different formats, and that this data, represents endpoints and starting points, and ranges for any combination of the data points. For example, if a particular data point “10” and a particular data point “15” are disclosed, it is understood that greater than, greater than or equal to, less than, less than or equal to, and equal to 10 and 15 are considered disclosed as well as between 10 and 15. It is also understood that each unit between two particular units are also disclosed. For example, if 10 and 15 are disclosed, then 11, 12, 13, and 14 are also disclosed.

As used herein, “real time” refers to the actual time that an analysis or monitoring takes place.

Section headers and/or titles are used for ease of review only and in no way limit any combination of features described herein.

### The Role of Intoxicants in Unwanted Sexual Interactions.

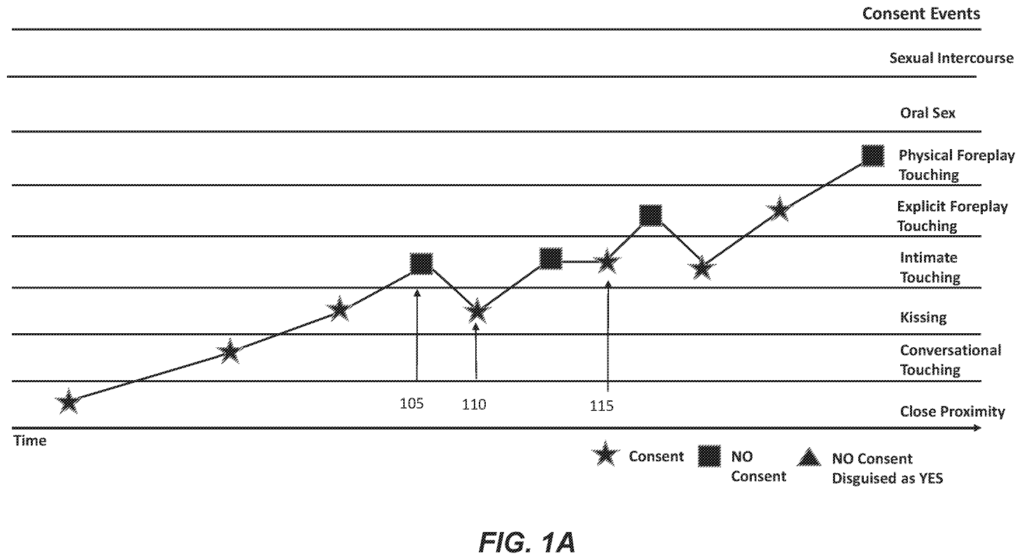

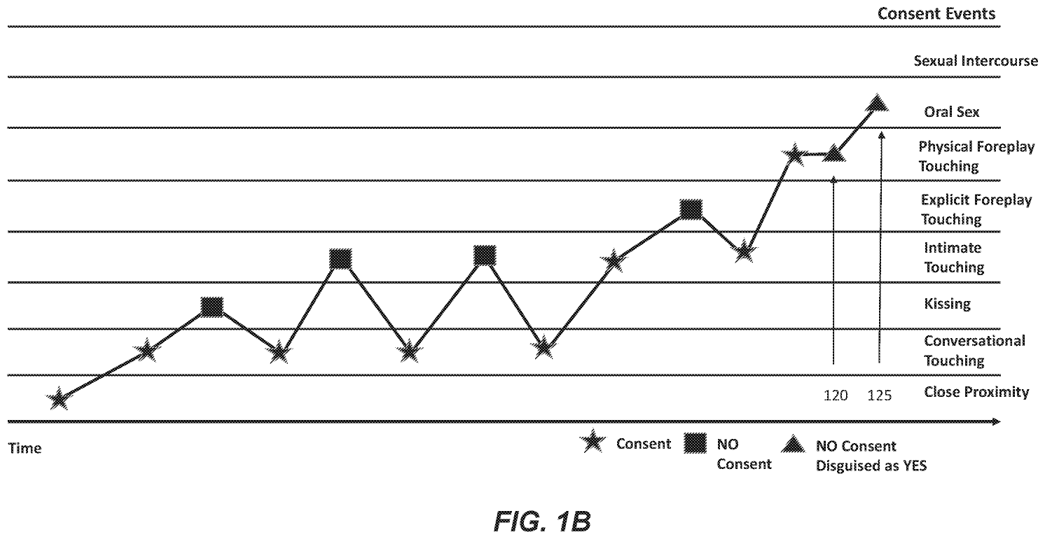

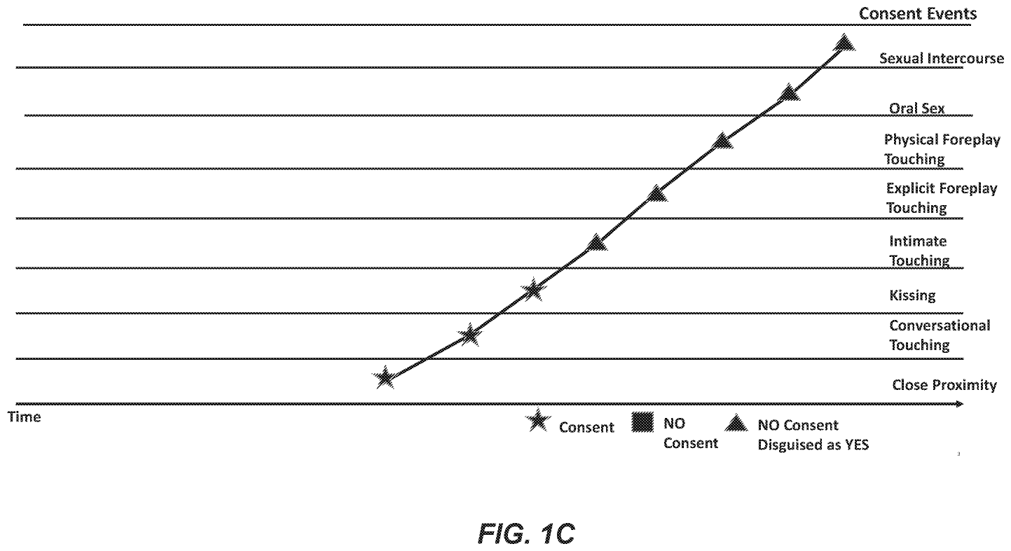

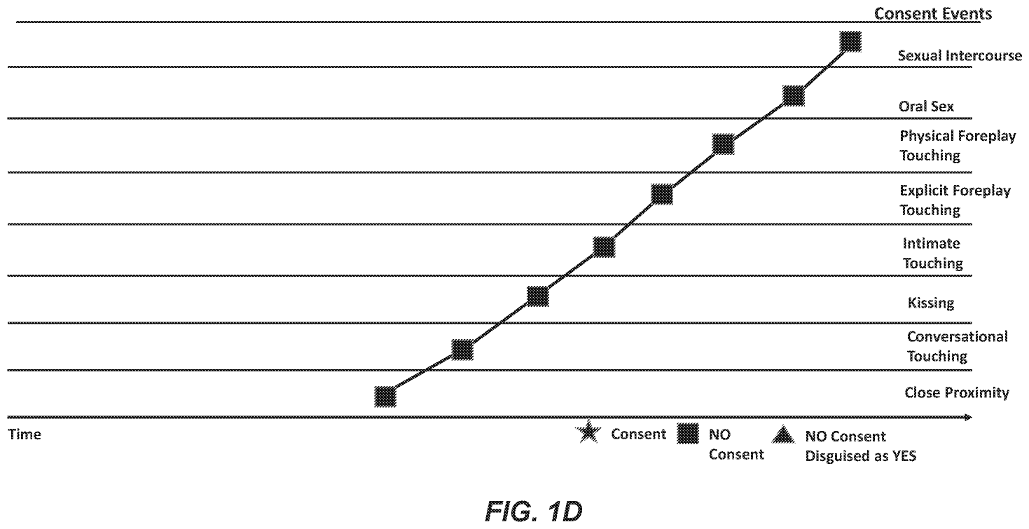

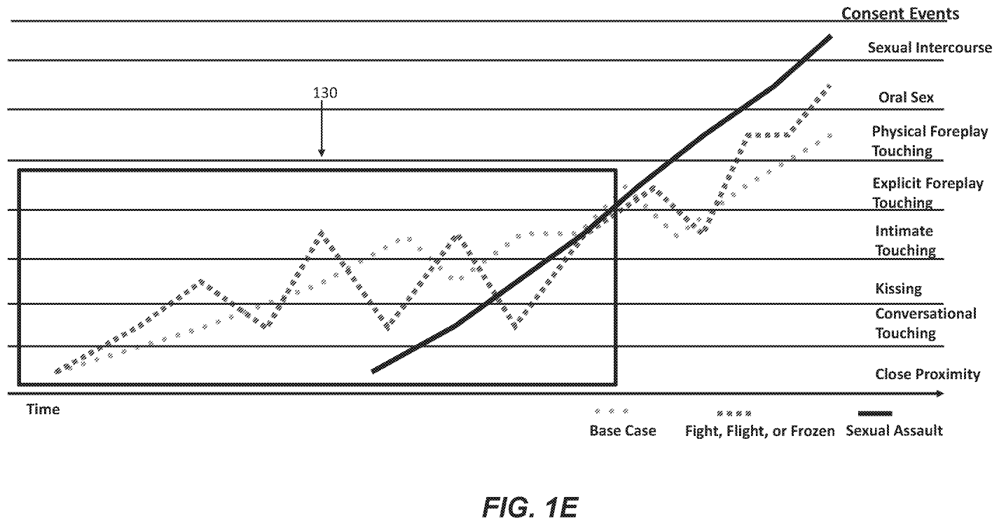

The influence of intoxicants may be seen in consent/lack of consent in various typical examples of social engagement where escalation of sexual intimacy may become problematic. One scenario is shown in FIG. 1A, where increased levels of intimacy are shown on the y-axis, with some specific thresholds labelled at the right hand side of the graphic. Advances to the next level of intimacy may be mutually agreeable as shown (star symbol), or may not be mutually agreeable. In FIG. 1A, escalation at a particular time point may be not consented to (square symbol, at 105). In this scenario, the lack of consent is made evident, and the level of intimate contact is decreased (110) until such time that both individuals are comfortable with increasing the level of intimacy (115). In this scenario, both individuals are communicating transparently and clearly, and are not advancing to greater intimacy without clear agreement by both parties.

In FIG. 1B, advances in intimacy, 120 and 125, are not equally agreed to. However, the lack of consent is here disguised as a “yes” (triangle symbol). The non-consenting individual has not made her/his lack of consent clear; there is no transparent and honest communication. In this case, the non-consenting individual may be under the influence of an intoxicant, but not to the extent that s/he is incapable of giving consent. However, s/he is making a compromised decision. S/He may not feel comfortable making a decisive action to signify non-consent for any number of reasons. This can often occur when the individual concerned additionally is inexperienced, feeling lack of power in the relationship, does not have a way to leave the setting, or feels socially pressured into not clearly signifying non-consent. The individual may be afraid to state her/his lack of consent. The responding individual may be limited to reaction by fight, flight or becoming frozen, e.g., incapable of extricating her/himself. The result is an intimacy that is not truly agreed upon, creating a situation where the non-actively agreeing party may feel coerced or violated. This impacts the initiating individual, as well, as s/he did not obtain clear understanding that the responding individual really did not consent, and may be unaware that the responding individual may feel that events occurred without her/his agreement.

In FIG. 1C, a responding individual repeatedly does not make her/his lack of consent clear, as the level of intimacies increase. This may be when the responding individual is voluntarily incapacitated, e.g., has voluntarily consumed enough intoxicant to be legally incapable of giving consent. This is sexual assault even if the responding individual has not made a clear statement of non-consent. The initiating individual is still responsible for having perpetrated an attack, despite perhaps thinking that her/his actions were reciprocated.

In FIG. 1D, the responding individual has been involuntarily incapacitated during the time of the interaction by intoxicants provided by the initiating individual. The responding individual is legally incapable of giving consent to any of the interactions between the two individuals, an instance of sexual intercourse is rape. The responding individual does not have a way to extricate herself/himself and no third party intervenes to prevent the bad actor from proceeding.

Finally in FIG. 1E, these scenarios are overlaid to show a period of time bounded by box 130, where a combination of passive blood intoxicant level monitoring and an interactive peer-to-peer network may provide the opportunity to intervene to prevent unwanted escalations of intimacy. Applicant describes an active/passive alert system including a peer-to-peer social network. The system enhances open communication and provides stimulus to enable frank agreement to new intimacies. The use of the systems, devices and methods described herein may be used to promote personal wellbeing, and in particular, prevent scenarios of sexual assault.

System. Systems are provided herein for assuring personal wellbeing, including personal safety. A system includes a wearable device and a non-transitory computer-readable medium in which a program is stored for causing a computer to perform a method for monitoring and/or controlling at least one of acceptable social interaction levels; a geographic location definition, a Blood Intoxicant Level (BIL) limit; a trusted companion network status; and, optionally, self-awareness monitoring. The non-transitory computer readable medium may be part of a mobile phone and/or web based software application, and provide a user interface for inputting and maintaining information related to the methods, and for receiving and sending notifications and alerts concerning personal safety and/or personal wellbeing. The non-transitory computer readable medium will be referred to herein as the mobile/web-based software application for simplicity.

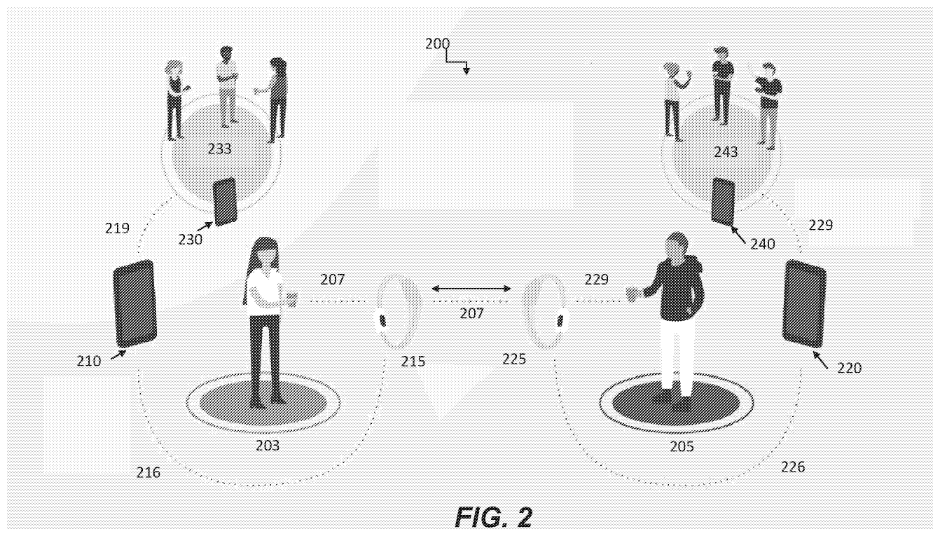

The system as illustrated in FIG. 2 provides connection between a first wearer 203 wearing a wearable device 215 and a trusted companion network 233, sending information 207 about the first wearer 203 from the wearable device 215 to the first wearer 203 as well as sending information 216 about the first wearer 203 from the wearable device 215 to the associated mobile phone 210/web based software application. From the associated mobile phone 210/web-based application, information 219 about the first wearer 203 is transmitted to the mobile phone(s) 203 of the trusted companion network 233 of wearer 203. Connection is further provided by the system between the first wearer 203 and a second wearer 205 of a second wearable device 225, permitting information 207 to be transmitted between the first wearable device 215 and the second wearable device 225, which may include information about the first wearer 205 and/or the second wearer 205, which may be transmitted onward to the respective individuals (207, 229). As shown in FIG. 2, the second wearer 205 also receives information 229 from the second wearable device 225 about the second wearer 205. The second wearer 205 is respectively connected, with information 226 being transmitted to the second wearer's associated mobile phone 220/web-based software application about the second wearer 205, which is transmitted onward to the mobile phone(s) 240 of the trusted companion network 243 of the second wearer 205. The systems, devices and methods are more fully described below.

Wearable device. The wearable device includes a blood intoxicant level (BIL) sensor; a communications hub; and an attaching linker, wherein the attaching linker secures the BIL sensor in proximity to a region of skin of an individual for sensing a BIL. A variety of wearable device configurations are possible and the invention is not limited to the specific configurations described herein. However, several examples of wearable devices are specifically described and shown throughout the Figures.

Blood Intoxicant Level (BIL) Sensor. Intoxicating substances may enter the bloodstream either voluntarily, through known ingestion/inhalation or other routes of known administration. Alternatively, intoxicating substance may enter the blood stream involuntarily via administration without the individual's knowledge or agreement. The intoxicants which may be monitored by the sensor include, but are not limited to alcohol, cannabinoids, opiates, and benzodiazepines. Other pharmacological agents may contribute to incapacitation and lack of cognitive ability to give consent, and may also be monitored by the BIL sensor of the wearable device. For simplicity, the discussion regarding sensing intoxicants will be directed to detecting Blood Alcohol Content (BAC), but the systems, devices and methods are not so limited.

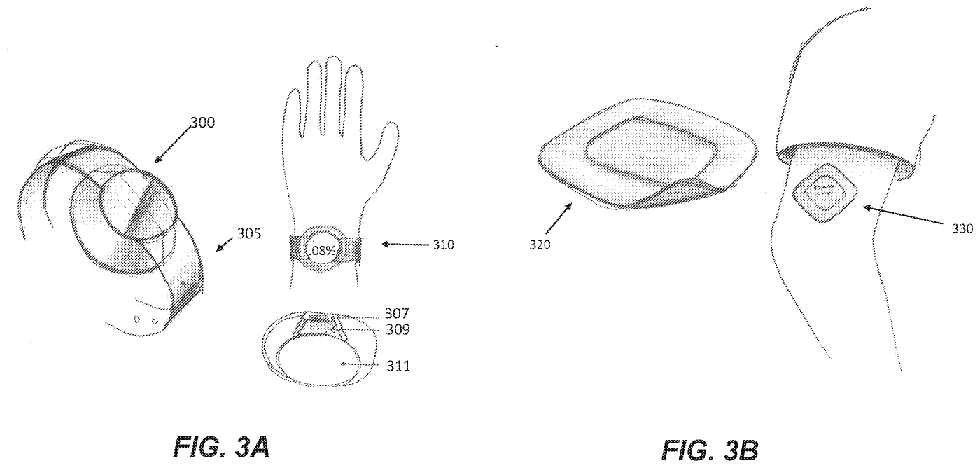

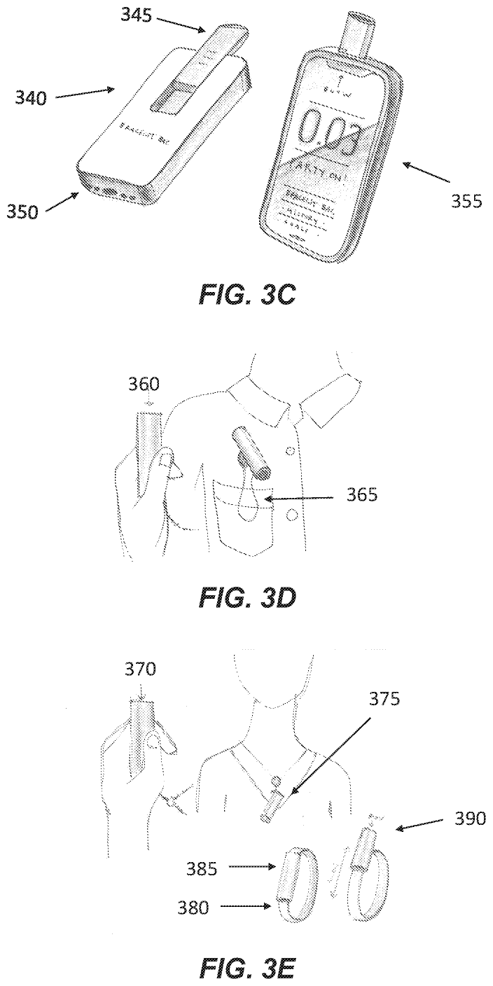

In some variations, the BAC sensor detection may be designed to be passive, and require no active input from the wearer. Rather, the BAC sensor may be designed to detect BAC transdermally in real time. One variation of a transdermal BAC sensor 300 is shown in FIG. 3A. The BAC sensor may be part of a wristband, where a strap 305 is a linker that secures the BAC sensor to the wrist of the user (e.g., wearer). A cupped region 309 may trap a region above wrist 311 to permit trapping of alcohol vapor emitted from the wrist 311 into the trapped region 309, and is sensed by sensor unit 307. The top face 310 of the BAC sensor 300, may provide a visible real-time value of the BAC of the wearer. The BAC sensor may be attached via the wristband 305 to the communications hub and display of the wearable device or may be part of either component as is shown in 310, where the display 310 of the wearable device is disposed above the sensor 307 and trapped air region 309. In some other examples, the BAC sensor may be attached in proximity to skin at a region of finger, an ear, an arm or a leg, and be connected electronically to the other components of the wearable device. The BAC sensor may detect the BAC transdermally using spectroscopic detection, optionally using Near IR spectroscopy. The BAC level may be detected directly, e.g., the presence of alcohol itself is detected, as described in U.S. Application Publication No. 2015/0241347, the entire disclosure of which is hereby incorporated by reference. Alternatively, a marker for the presence of alcohol in blood is detected, such as cytochrome P450 levels, as described in US2018/055454, the entire disclosure of which is herein incorporated by reference. Other examples of transdermal detection of biological analytes in real time using Near-Infrared spectroscopy include NeoSpectra sensors (www.neospectra.com). The BAC sensor 300 may communicate electronically to the communications hub and display of the wearable device.

In another non-limiting example of a transdermal BAC sensor 320 as shown in FIG. 3B, the sensor may be incorporated within a thin patch that may be secured to the skin via adhesive 330, acting as a linker. The sensor may detect alcohol vapor emitted through the skin, similarly to sensor 300 or may alternatively be capable of sampling optically or sampling blood sub-dermally via microneedles to obtain a BAC level.

In some other variations, detection of the BAC level may be an active detection. As shown in FIGS. 3C-3E, three different examples of a BAC sensor requiring action on the part of the wearer are shown. The BAC sensor may connect to the other components of the wearable device electronically and may not be physically connected to the other components of the wearable device.

In FIG. 3C, a BAC sensor 340 that detects alcohol in the breath of a wearer is shown, incorporated as part of the mobile device 350 associated with the wearer. The sensor may be integrated into a clamshell pack that fits over the back of the mobile device. The sensing tube 345 may slide upward and protrude from the case to permit the wearer to breathe into the sensor 340. The sensor may directly or indirectly send the test results to the software application running on the mobile phone 350 and provide a visible reading 355 in real time.

Another example of a BAC sensor with active input from the wearer is shown in FIG. 3D, where the BAC sensor 360 may be secured to a pocket via a clip 365. The wearer breathes into BAC sensor 360, which is electronically connected to the communications hub and display of the wearable device. Two further examples of a BAC sensor is shown in FIG. 3E, where a BAC sensor 370 may be suspended on a neckband 375, permitting the wearer to actively breathe into the sensor without taking the neckband 375 off. The BAC sensor is electronically connected to the communications hub and display of the wearable device. Another BAC sensor 385 may be secured to a wristband 380, where the wearer may slide the BAC sensor to an operating positions 390 and actively breathe into the BAC sensor 390/385. The BAC sensor 390/385 may be connected via the wristband 380 to the communications hub and the display and may communicate electronically to the communications hub and display.

Monitoring a BAC level may be performed passively, and may be performed continuously or intermittently. In some variations, the BAC level may be determined about every 1, 2, 3, 4, 5, 6, 7, 7, 9, 10 min or more. In some variations, the incidences of determination of the BAC level may be selected to occur from about every 1 to about 10 min, 2 to about 9 min, about 3 to about 8 min, or about 4 min to about 6 min, or any period of time selected within any of these time points.

Communications hub. The communications hub includes a sensor/emitter, processor a display and a vibrational motor.

Sensor/Emitter. The communications hub may include a sensor, which may sense a signal from one or more other wearable devices. The type of signal that is sensed may include electrical, infrared, near-infrared, radio or any suitable form of signaling. The signal that is sensed may include identification of the signaling wearable device, type of signal sensed, and/or time stamp for receipt of signal. The sensor of the communications hub may sense an acknowledgment signal from a second or more wearable device, when the one or more individuals wearing the second or more wearable devices gesture with an acknowledgement gesture to form an in-situ social network. The sensor of the communications hub may sense a pairing signal from a second wearable device, when an individual wearing a second wearable device gestures using a pairing gesture to form a paired interaction or maintain a paired interaction. The sensor of the communications hub may sense a signal from a BIL sensor of the wearable device.

The communications hub may include a signal emitter configured to send a signal to one or more wearable devices. The signal may be any described herein. The emitter may send an acknowledgement signal to one or more other wearable devices as described herein, to request forming part of an in-situ social network. The signal emitter may send a pairing signal to a second wearable device, to request pairing with the person wearing the second wearable device, or to maintain the paired interaction. The signal emitter may alternatively send a signal to un-pair from the paired interaction. The signal emitter may send a signal to the paired second wearable device to initiate a vibrational alarm on the paired second wearable device.

Processor. The communications hub may further include a processor, which may send/receive information to/from the BIL sensor; initiate at least one visible signal of the display; and/or initiate the vibrational motor of the wearable device of the wearer. The processor may further include a messaging device configured to send information to a third party. The information may include alerts about the intoxication status of the wearer (which may be passive or active), or about the personal safety of the wearer, which may be an active alert initiated by the wearer. The information may include instructions to buzz the wearable device of a paired second wearable device, as well as sending/receiving selected personal identifying information to/from the communication hubs of the in-situ social network and/or a paired wearer of a second wearable device. The processor of the communications hub may further include a receiving device to receive information from a third party, which may include instructions to initiate the vibrational motor of the wearable device of the wearer. The processor of the communications hub may be configured to store information from a third party (e.g., a member of the in-situ social network, or an individual with whom the wearer has paired) for a pre-selected period of time. In other variations, the processor may store the information from the third party until deleted by the wearer of the wearable device.

The signaling emitter and/or the messaging device of the communications hub may utilize a mesh network of nearby wearable devices and/or mobile phones to relay, amplify and/or accelerate alerts, signals or notifications.

The processor may further include a geo-location device. The geo-location device may be actively or passively initiated to annotate the location of the wearer of the wearable device. The processor may be configured to transmit data to and receiving data from the software application of the system, which may controls at least one of acceptable interaction levels; a geographic location definition, a BIL limit; a trusted companion network status; and optionally, self-awareness monitoring.

User input interface. The communications hub may include a user input interface. The user input may include inputting a geographic location or a geographic range. Inputting the geographic location may include setting the location for a specified period of time and/or may include dropping a pin on a map on the associated mobile phone or web-based application. The user input may include a toggle to a preferred mode of “OK” signal, which may include a test of a preferred gesture. The use input may include a toggle to “uncomfortable” or “no consent” mode. The toggle may be a specific tap or extended pressure, or any other means of input described herein, and may further trigger vibrational alarms on a paired wearable device. The toggle may further initiate an alert to members of the trusted companion network. The user input may initiate a message to a third party, including but not limited to a request for a ring back. The request for ring back may be in the form of one or more of a text message, vibrational signal or visual signal (e.g., when the recipient is wearing another wearable device and is situated close by). This may further include a “panic button” mode to request emergency assistance immediately, as described below. The user input may further include a memory tag, to memorialize a particular moment, which may include a location, a photograph, a musical tag or other annotation, as described herein.

In some variations, the processor may transmit a signal to a second wearable device, based on the data received by the processor from the BIL sensor and the user input interface. The signal may be a visible signal and/or may be a vibrational signal on the receiving second wearable device.

In some variations as described herein, when the wearable device includes a stability detection subsystem comprising an accelerometer and a gyroscope, the accelerometer/gyroscope may or may not be physically connected to the communications hub and attaching linker, but in any case, is electronically connected to the processor. The processor may receive data from the accelerometer from a gesture signifying consent from the wearable device of the wearer, and may further receive data from a second wearable device from a gesture signifying consent from a second wearable device. In some variations, the processor may be configured to receive gyroscopic/accelerometer data and to initiate at least one of a visual alarm, a vibrational alarm and a message for help to a third party. The processor sending notification or message for help may utilize a mesh network of nearby wearable devices and/or mobile phones in order to efficiently route the message, alert or alarm to the trusted companion network or to emergency personnel.

In other variations, the processor may further include a self-awareness monitor and user input is used for at least one of self-monitoring stress levels and accessing stress reduction interventions.

In some variations, the communications hub may include a battery, which may be rechargeable. In some examples the communication hub may include a input for an electrical charger. In some other examples, the battery of the communications hub may be rechargeable by induction. In other variations, the battery may be a replaceable battery.

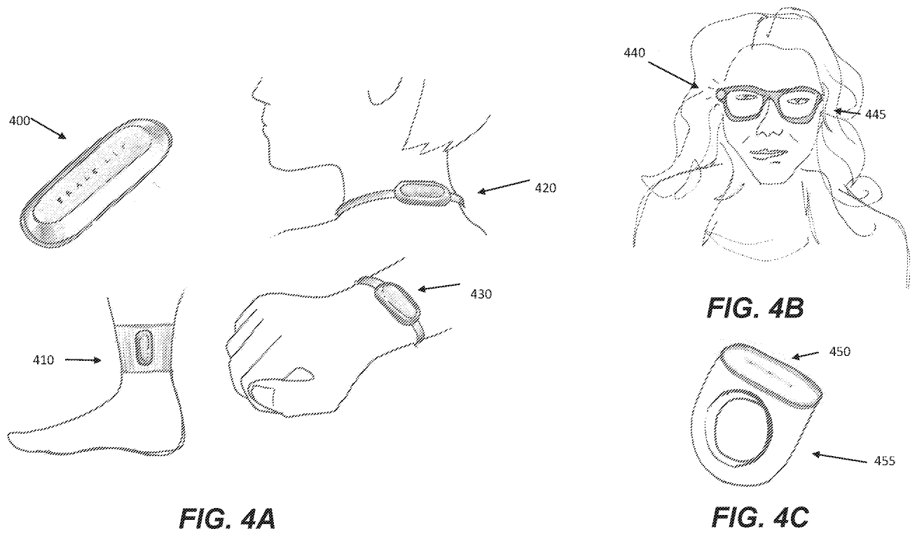

FIGS. 4A-4C show variations of the communications hub 400 of the wearable device. The communications hub may be incorporated into a band that may be worn at the lower leg, as shown in variation 410. Communications hub 410 may be connected electronically to the other components of the wearable device, including the BIL sensor, and display. In another variation communications hub 420 may be part of a neckband, which may or may not also contain the BIL sensor and display. In yet another example, the communications hub 430 may be attached to a wristband which may be the linker which physically links the communications hub 430 to the BIL sensor and display. In some other variations, the communications hub may further include the display of the wearable device incorporated within the housing of the communications hub, and secured to the BIL sensor via a wristband. In FIG. 4B, the communications hub 440 may be incorporated within the eyeglass frame 445, and may further include the display within its housing, which being connected electronically to the BIL sensor. In yet another embodiment, the communications hub 450 may be incorporated within a ring 455. The display of the wearable device may further be incorporated within the housing of the communications hub 450. The communications hub may be connected electronically to the BIL sensor or may incorporate the BIL sensor within its housing. The ring 455 may further include the vibrational motor and battery of the wearable device.

Display. The wearable device may include a display. The display may be configured to be easily viewable by other individuals in a social setting. The display may include at least one visible signal, and in some variations the display may have a set of visible signals, each having a spectrally distinct wavelength from about 450 nm to about 700 nm. Each of the set of visible signals may be produced at the same location of the wearable device or may be produced at different locations of the wearable device. In some examples, some of the set of visible signals may be produced at the same location, e.g., a light producing signal changes wavelength of the light produced, while some of the other visible signals are produced at different locations of the wearable device. In some variations, the visible signal may further include a variety of visible intensities and/or patterns of signaling. For example, a first threshold of BIL detected may initiate a first color change from a non-intoxicated level color indicator to a second color level, e.g., from a green color to a yellow color. If the BIL continues to increase, the second color level signal, e.g., yellow signal may start pulsating more rapidly as the BIL increases. Alternatively the color change may not be a state change, from green to yellow, but may change wavelength of visible color from green to yellow gradually, showing BIL change. When a second threshold to a severe level of BIL has been reached, second color may abruptly or gradually change from, for example, yellow, to red. The pulsation may further increase in frequency to alert the wearer and surrounding individuals that, for example a BAC level of over 0.20% has been reached.

In some examples of the display, the display is part of the communications hub. For example, in FIG. 4B, the communications hub 440 further includes the display, permitting a variety of signals to be readily visible to others. In FIG. 4C, the communications hub 450 of the wearable device fashioned as a ring 455, may further include the display on the surface of the communications hub 450.

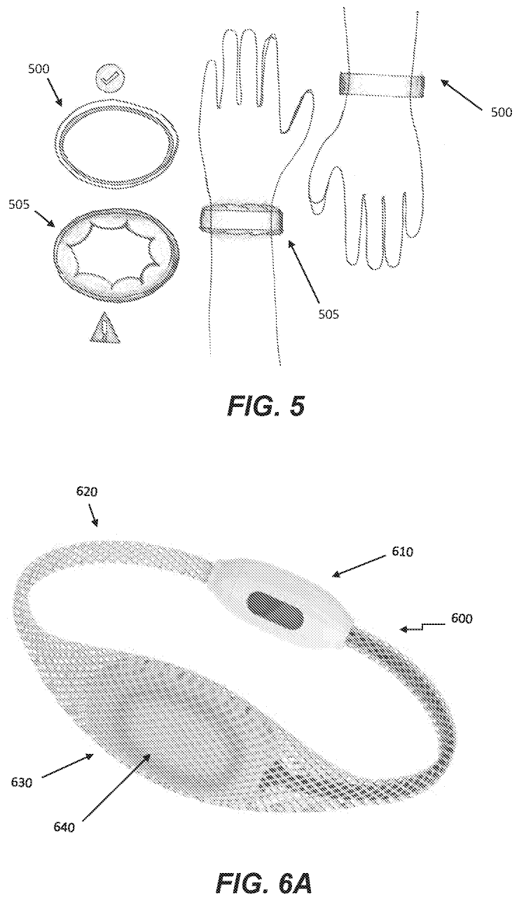

In other examples, some of the signals produced by the display may not be immediately evident to people other than the wearer. In FIG. 5, the wearable device is a wristband 500, and when in a non-alert state, it is a loosely fitting band 500. However when the BIL sensor has detected intoxicant levels that are over the safe threshold, the wristband may inflate to a second state 505 which is tight fitting, producing a different form of alert than a signal comprised of a visible light signal.

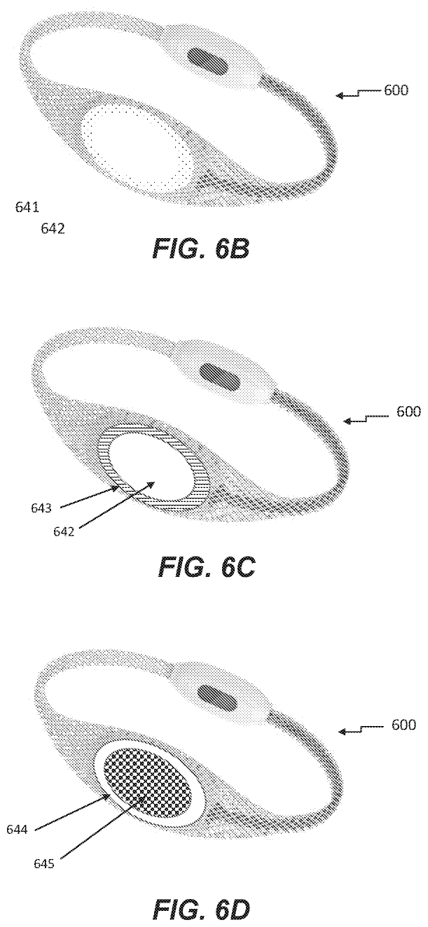

In another variation, a wearable device 600 is shown in FIG. 6A. The BIL sensor 610 is a Blood alcohol content sensor 610, and the attaching linker 620 secures the BAC sensor in close proximity to the skin at the wrist of a wearer. The attaching linker 620 is covered by a colored mesh wrapper, and provides fun styling for the wearer. The attaching linker and its associated wrapper may be provided in different lengths to insure that the BAC sensor will function properly. The length of the overall bracelet of this wearable device may be about 4 in, about 4.5 in, about 5 in, about 6 in, about 6.5 in, about 7 in, about 7.5 in, about 8 in, about 8.5 in, about 9 in, about 9.5 in, about 10 in, about 10.5 in, about 11 in, about 11.5 in, or any value between these lengths, e.g., the lengths may increase in units of a quarter of an inch or a tenth of an inch, in order to provide properly sized wearable devices. The BAC may be detected transdermally, as the skin at the wrist is very close to veins and arteries, which may provide the ability to transdermally sense the BAC of the bloodstream. The communications hub 630 contains a display 640.

In the wearable device 600 of FIG. 6A, the wristband 620 positions a display 640 region incorporated within the housing of the communications hub 630. Any of the display options including different signals or patterning of light signals may be used in a wearable device configured similarly to device 600. One example of the type of light signals useful in the wearable device 600 is shown in FIGS. 6B-6D. In the example shown in FIG. 6B, the display region 640 has two distinct sub-regions: 641, which forms a ring shaped region around sub-region 642. A first level of display signal may include a first color illuminating the sub-region 641. The first color signal, indicating no or low levels of intoxication, may be a green or blue color lighted display in region 641, while the central portion 642, is not displaying any color.

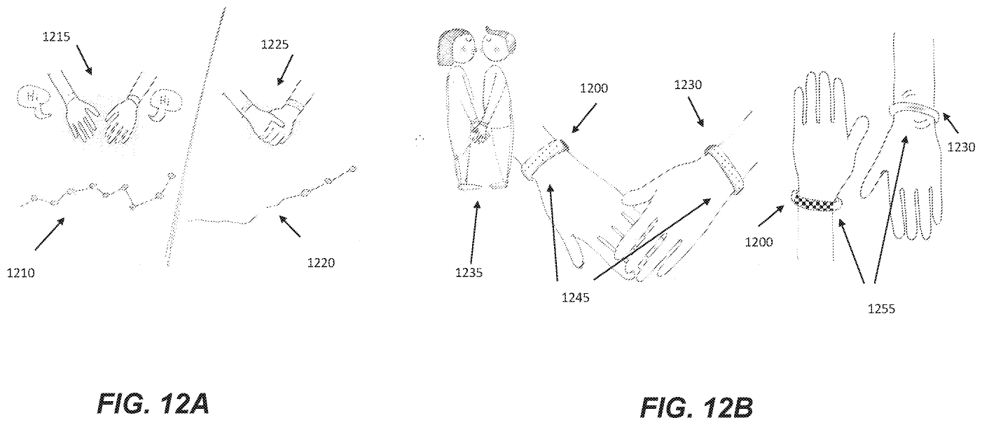

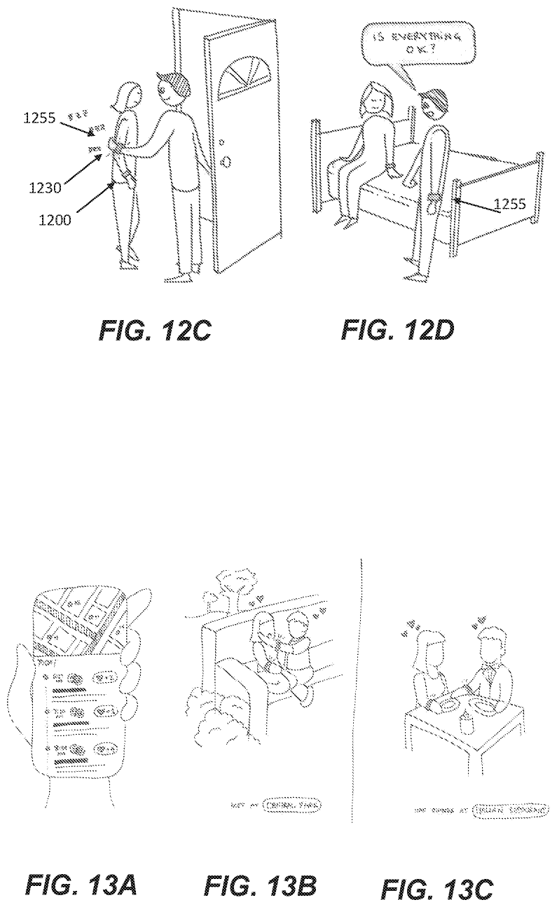

A second level of detected intoxication may be indicated as shown in FIG. 6C, where the region ringing the central portion of the display region 640 is now 643, a different color. This may be a yellow colored display, and the central portion 642 of the display region 640 is not colored. A third and highest level of detected intoxication may be displayed as shown in FIG. 6D, where the outer section of the display region, ringing the central display portion is not illuminated at all, 644, while the central portion of the display 645 now is illuminated with, for example, a red signal 645. This is only one example of many different combinations of colors and regions illumination possible, and the wearable device is not limited by the display shown in FIGS. 6B-6D. In some embodiments, the entire band of the wristband may act as a display, illustrated as shown in FIGS. 12A-12D, and may change color as intoxicants are detected. Further as discussed below, the wearer may actively input a change of color to a more advanced state of alert, if she/he is uncomfortable with the current activities.

Attaching linker. In some variations, the attaching linker of the wearable device may be designed to be waterproof. The attaching linker may be made of breathable materials such as a mesh fabric, plastic or metal links, or perforated solid materials such as a conforming plastic which permits the linker to deform against the region of the body where the wearable device is disposed. The attaching linker may attach the BIL sensor in proximity to skin at a region of a wrist, a neck, a finger, an ear, an arm or a leg. The attaching linker may be available in a variety of colors. In some variations, the attaching linker may include a detachable wrap which is decorative. The detachable wrap of the attaching linker may be changed to be a detachable wrap having a different color to contrast or complement the other clothing of a wearer. In this manner, the look of the wearable device may be moderated for a particular event, or may be altered to provide a graphic or other event-specific motif.

In some variations, the BIL sensor and the communications hub are connected to or disposed upon the attaching linker. Alternatively, the communications hub may be connected to or attached to the attaching linker, while the BIL sensor may be in electronic communication with the communications hub. In this variation, the BIL sensor may not be physically linked to the communications hub or the attaching linker.

In some variations, the attaching linker is a wristband.

Accelerometer/gyroscope. In some embodiments, the wearable device includes an accelerometer/gyroscope component, which may be physically incorporated within the wearable device or may be physically separable but in electronic contact with the wearable device. The accelerometer may be configured to be linked to the wearer at the waist, neck, ear, or ankle to detect deviations from vertical stance. The wearable device may be configured to receive and monitor electronic communications from the accelerometer/gyroscope.

Wearer input. The wearer may input different initiating actions upon the communications hub of the wearable device. While described here for the wristband type wearable device as in FIGS. 5, 6A-6D, 7A-7D, 8, 9A-9E, 10, 11A-11B, 12A-12D, 13A-13C, 14 and 15, similar or analogous motions may be used with the other types of communications hubs and wearable device configurations described herein.

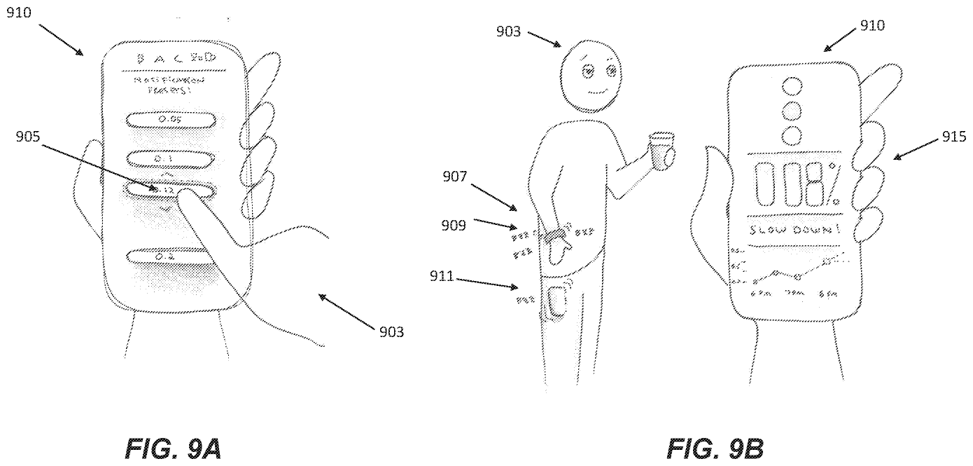

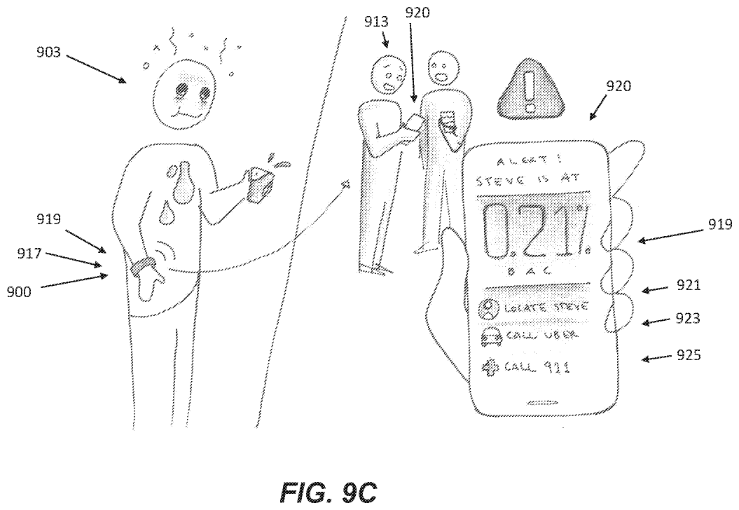

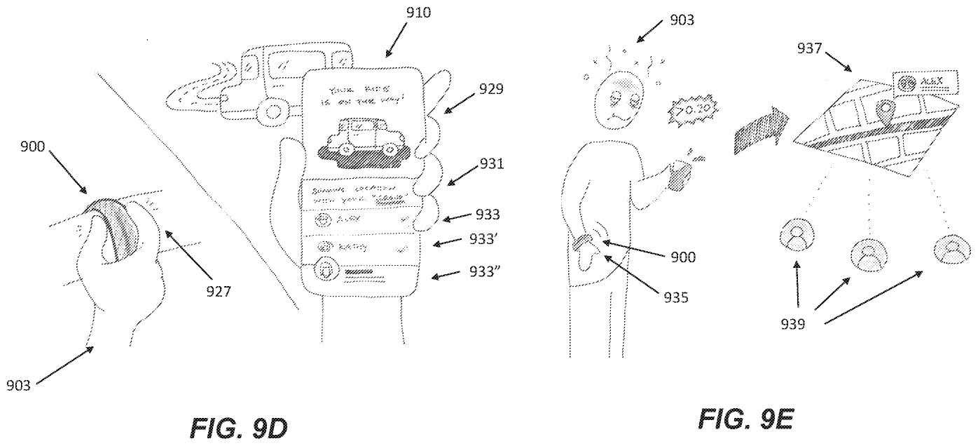

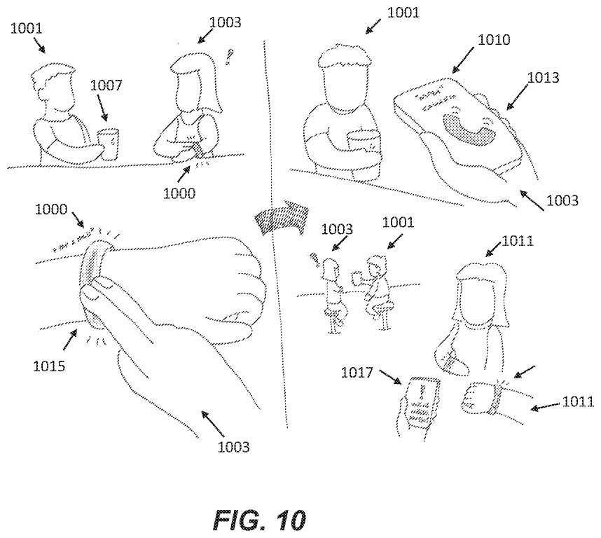

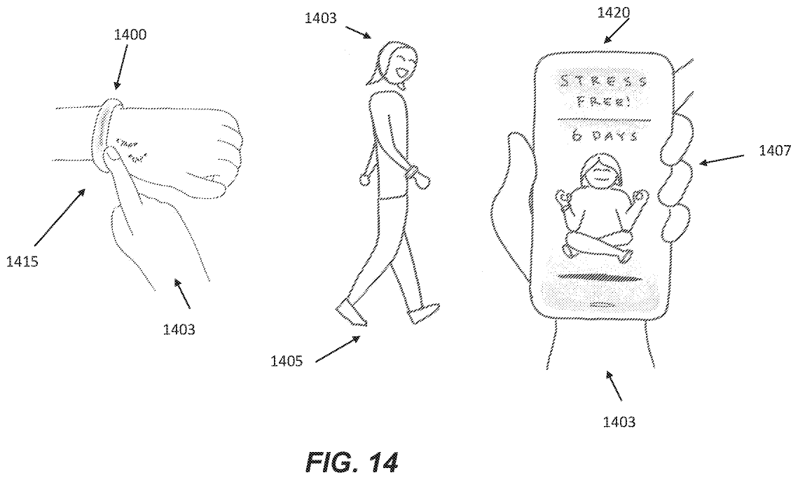

For example, a squeeze or pinching motion may be interpretable by the communications hub to send an alert to the trusted companion network; change the color signal on the display to a heightened level of signal to indicate unease, or to obtain emergency assistance or a ride service. One example of “squeeze” or pinch is shown in FIG. 9D. Another type of wearer input may include a tap and hold, which may send an alert to a trusted companion, without changing a color status on the wearable device. This may summon nearby help from a trusted companion as illustrated in FIG. 10, and described more fully below. Additionally, a touch or quick tap may be interpretable by the communications hub as a request for a status update on personal wellbeing data points, and is illustrated in FIG. 14A.

Further wearer input actions are described for interactive engagements using the wearable devices in the following paragraphs.

Interactive aspect of the wearable device. Several levels of interaction between the wearable device (first wearable device) of the wearer and other individuals may be effected.

Trusted companion. The wearer may actively include one or more individuals in a selected “trusted companion” network. The trusted companions may be solicited by the wearer to receive passive or active alerts/notifications for a specific event, and to be available to assist the wearer if called upon by an alert/notification. The members of the trusted companion network may receive alerts from the first wearable device and may send notifications from respective wearable devices or respective associated mobile phones of the trusted companion network. As shown in FIG. 9D, not every member of the trusted companion network of the wearer is necessarily notified or alerted for a particular event. The wearer may consult with his/her trusted companion network prior to an engagement to inquire as to which of the trusted companions may be available to be notified/alerted for that event. The associated mobile phone of the wearer shows two individuals, “Alex” and “Kathy” who are active in the trusted companion network at that time, while a third individual is greyed out and not available.

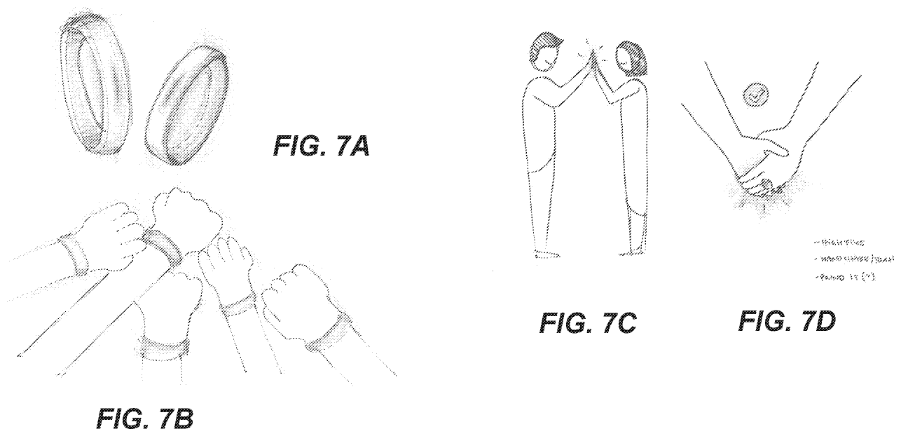

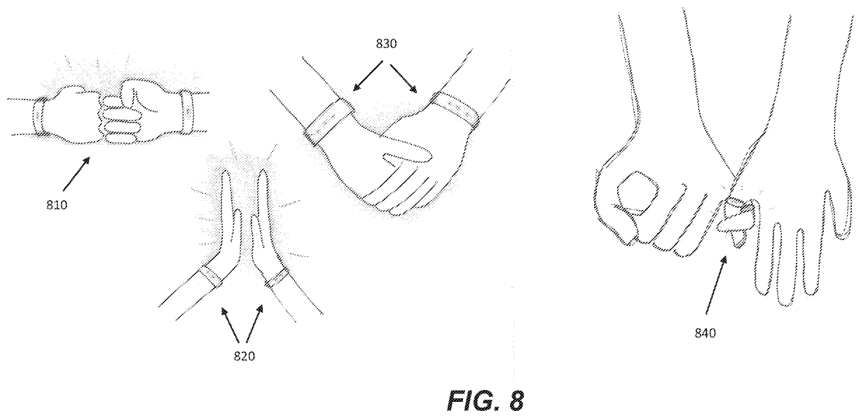

Social participant. A more casual level of interaction may be invoked by performing an acknowledgement gesture (e.g., bumping the first wearable device quickly to a second wearable device of a second person) between the wearer of the first wearable device and one or more other wearers of respective wearable devices to create a “social” level of interaction between the first wearable device and the respective wearable devices. The acknowledgement gesture may be a group gesture such as raising a hand to be within 6 in, 1 foot, 18 in, 2 feet, or a larger distance of one or more other hands of other wearers of wearable devices, as shown in FIG. 7B. Alternatively, a first bump 810, as shown in FIG. 8, may be performed for a pre-selected period of time. In yet another example, a quick “high-five” gesture 820 may be performed for a pre-selected period of time. The period of time that the gesture is maintained to create the social level of engagement may be about 0.5 sec to about 3 sec, or any value therebetween. The gesture is maintained long enough that the respective wearable devices can register each of the other wearable devices being acknowledged. The communications hub of each wearable device can detect the acknowledgement gesture, and register the one or more other wearable devices.

The communications hub of each of the wearable devices included in the acknowledgement may receive and send some identifying data. The identifying data may be a registration number of the respective wearable devices or may be some brief personal identifying information pre-selected by each wearer, which identifies them by a first name, a nickname, a screen name or other identifier selected by each wearer.

After a specific social engagement has ended, the wearer may have an opportunity to edit or delete information received or sent via the acknowledgement gestures of that evening. In some variations, the brief personal identifying information may automatically be erased from each wearable device at a selected time point after the social engagement unless the wearer actively inputs a “save” action within that selected period of time. The time point when personal identifying information is automatically erased from the wearable device and the associated mobile phone/web-based application may be within about 24 hr, 36 hr, 48 hr, 3 days, or a week. The time point may be any period of time between the values shown here.

The social level of interaction may be a “nice to know you” association, and give notice of a shared desire for an enjoyable social engagement and a shared agreement to interact responsibly and caringly with each other. The social level of interaction may be gamified, which may incentivize individuals to participate, as described in more detail below. The social level of interaction may further be understood by wearers of the wearable devices to include sharing positive enhancement of outcomes for all engaged at a social engagement, thereby forming an in-situ social network at that engagement. Formation of the in-situ social network may include a presumption of willingness to aid or assist when visible need arises or when alerts are either visibly evident, e.g., the first wearer's wearable device has changed color alerts to a stop/danger level, or passively activated or wearer-activated alerts may be sent to all wearable devices within a specified area around a wearer who is experiencing a problematic situation.

Paired individual. Further, a first wearer may “pair” the wearer's wearable device (first wearable device) to the wearable device of a second person (second wearable device) during a social engagement, by interchanging a “pairing” gesture, which may be, for instance, tapping the first wearable device and the second wearable device together for a specified period as shown in FIG. 7A or performing a first bump 810 as shown in FIG. 8, typically longer than a “bump” gesture used for the in-situ social network. Other pairing gestures may include: bringing the two devices into contact for a pre-selected period of time by holding hands 830, as shown in FIG. 8 or FIG. 7D (when the wearable device is a ring); a “high-five” gesture, as in FIG. 7C, which brings the two devices together at an elevated position relative to a resting state; linking fingers 840 for a pre-selected time, as shown in FIG. 8, when the wearable device is a ring; a gesture of inclining the wearers' heads towards each other for a pre-selected period of time when the wearable device is necklace/neckband.

The pre-selected period of time used to pair two wearable devices together may be selected to be about 1 sec, about 2 sec, about 3 sec, about 4 sec, about 5 sec or longer. Upon pairing, information may be sent across the paired devices, such as nicknames or other pre-selected personal information. The information sent to a paired wearable device may also be sent to the members of the trusted companion network. The pair association may be a one-to-one interaction, and may indicate a desire for closer interaction. The pair association may create a more interactive set of alerts and notifications between the first wearable device and the second wearable device. The communications hub of the first wearable device may send alerts to the “paired” second wearable device, and vice-versa. In the event that one or both of the two parties wish to dis-engage from the paired interaction, one or both wearers may shake their wearable device(s) to “unpair” from the paired interaction. The personal information sent to the second wearable device of the second wearer and/or the personal information received by the first wearable device of the first wearer may be selectively deleted by the first wearer and/or the second wearer upon unpairing. This may be performed at the user interface of the associated mobile device or web-based application.

Passive Intoxicant Monitoring with Real-Time alerts. FIG. 9A shows a wearer 903 providing input on the associated mobile/web application interface 910. The software enabled mobile/web-based interface for establishing Blood Alcohol Concentration pre-set alerts is shown, where a wearer may enter 905 preset levels of BAC for which the wearer will get alerts or alerts will be sent to the trusted companion network.

An initial level may be set, such as 0.05% BAC, as a reminder that a wearer has imbibed an alcoholic substance. This initial level of alert may be a text alert. It may additionally or alternatively be a visible alert, such as a colored signal 907 on the display of the wearable device or a color change of at least a portion of the wearable device. The colored signal may be a first color when the wearer has a BAC below the initial preset level of alert; a second color after passing the threshold for the first preset level of alert; and a third color when passing the next level of BAC level alert. In yet another embodiment, the alert may be a single period of vibrational alert 909 from the wearable device and/or a vibrational alert 911 from the mobile phone associated with the wearable device. Alternatively, the alert may be a first pattern of vibrational or visible alert emanating from the wearable device and/or from the associated mobile phone. The alert 915 may include a graphical display on the associated mobile device of the wearer's BAC over time, and may further include notifications (e.g., text messages) to the trusted companion network of the wearer.

The wearer may preselect more than one level of BAC for which the wearer will receive an alert. For example, if the wearer is at a bar on a weeknight, the wearer may pre-set a second, cut-off alert to a level of BAC that is lower than a BAC level that the wearer might choose on a weekend night. In another example, the wearer may set a second, cut-off alert at a BAC that is lower than the local legal impaired driving BAC level, e.g., less than about 0.08% for some localities.

The wearer may also select the preset alert levels available from the mobile/web-based application. The pre-set alert levels presented by the mobile/web-based application may include a machine learning algorithm, which may be trained to predict the wearer's individualized pattern of behavior. For example, the algorithm may “learn” that the wearer reacts to a certain level of BAC by accelerating alcohol intake, and may present a more sharply intensified alert system. In another example the algorithm may “learn” that the wearer reacts to a given BAC in a more pronounced manner than typical for the general populace, e.g., by acting more impaired, and resultantly may set lower levels of BAC to alert the wearer in advance of the wearer's specific reaction to alcohol.

As shown in FIG. 9B, the higher levels of alert selected by the wearer may result in increasingly noticeable alerts initiated by the communications hub of the wearable device or the associated mobile/web-based applications. The intensified alerts may include color signals associated with stopping activity, such as color change of at least a portion of the wearable device to yellow color upon passing a first threshold, or a color change of at least a portion of the wearable device to a red color, upon passing a second, higher BAC level threshold. The intensified alerts may be mirrored on the associated mobile device. The intensified alerts may also be mirrored with vibrational alerts on the wearable device or may include text messages to the associated mobile phone that will vibrate the phone. The intensified alerts may be designed to become more intrusive or annoying, and may further require an active input from the wearer upon the wearable device or the associated mobile phone to stop the annoying/intrusive alert for a period of time. The input from the wearer may include acknowledgement by the wearer that these threshold(s) have been passed. The active input by the wearer may include tapping on the wearable device to stop the display and/or vibrational alerts. In some variations, the wearer may input a code to acknowledge the alert and stop a vibrational alarm. The code may include any form of input, such as a pattern of taps, which may vary the location, duration or number of taps on the wearable device. The duration of the stop of an annoying/intrusive alert may also be a preset period of time that the wearer may set for general use or for a particular one-time event. The vibrational alerts may have a duration of about 10 sec to about 3 min, about 15 sec to about 1 min, about 20 sec to about 45 sec, or any value selected between any of these values.

A paired second wearable device can receive alerts similarly to the first wearable device of the first wearer. The alarms sent to the second wearable device may include heightened alarming or intrusive notifications to put the second wearer on notice that the BAC of the first wearer is elevating to a different level, and that that individual may be entering a level of BAC at that point or in the very short term, in which the first wearer will not be capable of giving consent to further, more intimate interactions. The second wearer of the “paired” wearable device may be required to acknowledge the alert that the first wearer is approaching or is at a BAC level where consent is not possible. The second wearer may be required to input the acknowledgement by tapping the “paired” second wearable device, which may include entering a code, in order to stop the vibrational alert sent to the “paired” second wearable device. The code may be like the code described above for the first wearer.

The second wearer of the “paired” second wearable device is thereby put on notice that informed consent is not possible, which may be a deterrent to non-consensual interpersonal/sexual interactions.

In some embodiments, the wearer may not be permitted to stop the annoying/intrusive alarm for more than a selected period of time, to prevent disabling of the alert system. The period of time that a wearer may be permitted to stop a repeat of an annoying/intrusive alert may further be modulated by the machine learning algorithm, based on prior instances of issuance of these alerts.

In FIG. 9C, the BIL sensor may detect an intoxication level, which may be a dangerous level for the wearer 903, such as a BAC of 0.20 or over. The wearable device 900 and the associated mobile/web based application may initiate advanced levels of notification alerts in real time, as the intoxication level is detected by the sensor. The wearable device 900 may present a final alarm colored signal 917 (e.g., color change of at least a portion of the wearable device, such as a red signal color). The wearable device 900 may further provide a vibrational alarm 919.

When the wearable device 900 and/or the mobile/web-based application receives the sensor reading of a dangerous level of intoxication, such as a BAC level (e.g., 0.20%) which may result in blackout, the communications hub of the wearable device 900 may send notification 919 to the trusted companion network (shown here as individual 913) to alert him via his mobile phone 920 that the wearer 903 needs assistance. Further if one or more of the trusted companion network has a respective wearable device, the respective wearable device of the one or more members of the trusted companion network may receive an alarm on the respective wearable device, e.g., a vibrational alarm may be triggered, which alerts them to the alert 919 on the trusted companion's phone 920. The alert may include identification of the wearer 903 (“Steve”). In some embodiments, information may be sent concerning the BAC level of the wearer 903. The alert may also include an action button 921 to find the wearer 903 (which may include initiating a telephone call to the wearer 903 or to locate via a geolocation app), an action button 923 to call a ride, and/or an action button 925 to call for emergency assistance. The members of the in-situ social network at the current social engagement may also receive an alert or vibrational alarm, with some or all of the information sent to the trusted companion network. Individuals of the in-situ social network may be alerted to look for and assist a wearer 903 who is in need of assistance.

The wearable device or the mobile/web based application may be configured to collect geographical locator information.

In some embodiments, the wearable device is configured to receive and monitor electronic communications from the accelerometer/gyroscope, if present within the wearable device system. If the accelerometer/gyroscope sends electronic communication indicating that the wearer has lost control of their mobility, most generally, when in combination with the detection of a dangerous level of BAC, yet another level of alarm may be sent to at least one of the in-situ social network, the trusted companion network and to emergency personnel, along with the geographic location of the wearer and a pre-set amount of personal identifying information. In some embodiments, the member(s) of the in-situ social network or the trusted companion network may be requested to accompany the wearer to their safe location so that an incapacitated person is not deposited unaccompanied into a ride-sharing vehicle.

A “paired” second wearable device of a second wearer may also be sent an alert such as an intensified vibrational alert to create a barrier to advancing intimate behaviors. The associated mobile phone of the second person may present a text or other message visually announcing the dangerous level of intoxication of the first wearer to further alert the second wearer of the wearer's lack of ability to give consent. The alert may further include an actionable ride—hailing radio button to facilitate safe delivery of the wearer to the wearer's residence or other safe location.

In addition to the passive alerts described above, FIG. 9D shows the wearable device 900 being used actively by the wearer 903 to obtain assistance when the wearer has transitioned to a state of unwellness from intoxicants or any other debilitating state. Other reasons for incapacitating unwellness such as migraines, severe menstrual cramps, susceptibility to seizures including but not limited to epileptic seizures, or asthma attack may also be an initiating event. A prescribed tap or squeeze action 927 to the wearable device 900 may actively send an alert 929 to the wearer's associated mobile phone. The alert may convey information about actions taken by the communications hub/web-based application such as notification 931, showing that trusted companions 933, 933′ have been notified, and that, in this instance, a ride has been requested 929. The notification may also show that one of the trusted companions 933″ was not notified.

In FIG. 9E, a scenario is illustrated wherein a wearer 903 passes the threshold for a dangerous level of BAC (e.g., over 0.20%) and the passive notification and alerts have been issued. Device 900 may initiate the final color signal and vibrational alert 935 to the wearer 903, and may send a notification 937 to trusted companions 939 giving them geographic locator information for wearer 903. In some embodiments, as well as the trusted companion network, a ride service and/or emergency assistance may be sent the name and location of the wearer. Optionally, a photograph of the wearer may be sent as well. The associated mobile of the wearer and/or the mobile phone of the trusted companion network member notified may include action buttons to call for a ride to take the wearer away from the site, may call for medical assistance, or may notify the wearer/trusted companion network member of the nearest location of an emergency room or urgent care facility. The in-situ social network may also be sent an alert, to notify them to look for and assist wearer 903. The alert may include a specific geolocation within the event site and may include a photo and other personal identification to enable a member of the in-situ social network to easily identify the person in need.

User active input during social engagements. The use of the wearable device to send alerts and request assistance may be extended beyond scenarios involving intoxication-related consent. The system of the wearable device/associated mobile/web application may be used to ensure that only mutually agreeable interactions are continued as an interaction or relationship intensifies. In FIG. 10, the self-initiated use of the alert system is shown. For example, wearer 1003 is engaged socially with another person 1001, who may be offering wearer 1003 a beverage 1007 with which the wearer 1003 is uncomfortable. The wearer 1003 may be uncertain how to refuse and/or may be concerned about accepting the beverage from person 1001. The individual 1001, as shown in FIG. 10, may not wear a wearable device, or may wear a device to which the wearer 1003 is not paired or with whom the wearer 1003 does not want to be paired. The wearer 1003 may initiate an alert 1005 to obtain assistance. The alert 1005 may be initiated by tapping 1015 on the wearable device 1000. The alert may request a callback via text message to a friend or a member of the trusted companion network. The incoming telephone call 1013 may be just a quick status check. Alternatively, the incoming call 1013 may offer a nonconfrontational way to withdraw from the individual 1001. Further, the communications hub of the wearable device/associated mobile phone may send an alert 1017 to a trusted companion 1011 in the vicinity to come to the aid of wearer 1003 to help actively withdraw the wearer 1003 from the uncomfortable situation.

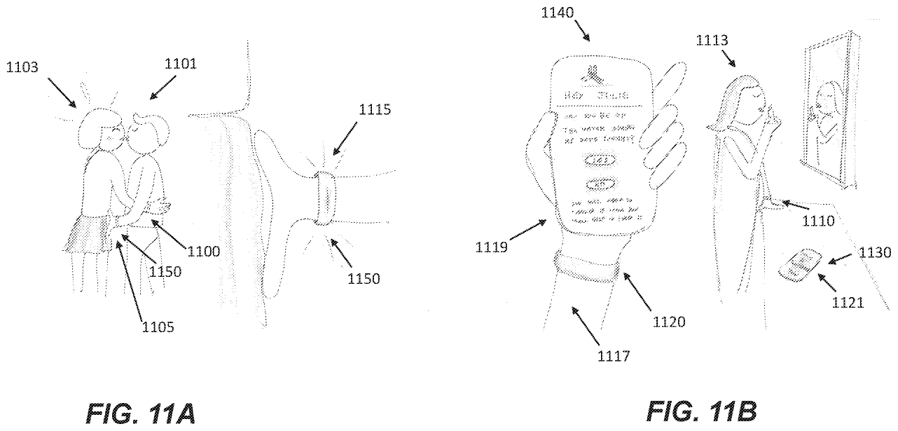

In another scenario, as shown in FIG. 11A, the wearable device 1100 and associated mobile/web based application of a wearer 1103 may be activated to notify the wearer 1101 wearing a paired wearable device 1150 that the wearer 1103 is not comfortable with the current activity 1105 occurring between wearer 1103 and wearer 1101. The wearer 1103 may initiate an alert. The alert may include a color change on the wearable device 1100 of wearer 1103 to a higher level indicating discomfort (e.g., a yellow or red signal). Additionally, the alert may initiate a vibrational alert 1115 on the wearable device 1150 of the individual 1101. The wearer 1101 is signaled that the current activity is not acceptable. As described previously, wearer 1101 acknowledges the alert 115, which turns off the vibrational alert. Wearer 1101 is then put on notice of lack of consent, and is expected to de-escalate the current interaction.

Additionally, as shown in FIG. 11B, if a wearer 1113, wearing the wearable device 1110, anticipates or is fearful that during the course of an social engagement, that unwanted escalations of interactions with another person may occur, the wearer 1113 may initiate a request 1119 to a selected member 1117 of the trusted companion network, which may appear as a text message or other deliverable form to the associated mobile 1140 of trusted companion network member 1117, wearing wearable device 1120 to be ready to assist the wearer 1113. The wearer 1113 may receive a message 1121 on the associated mobile phone 1130 of wearer 1113, back from the wearer 1117 acknowledging and agreeing to the request to monitor for further alerts during the social engagement.

In various embodiments, if the wearer is facing an immediate personal safety risk, emergency assistance from safety officers may be requested unobtrusively.

Evolving a physical relationship with comity between two wearers of paired wearable devices. Building relationships and sexual intimacy through real communication The wearable device and associated mobile/web-based application may be used to promote mutually agreeable progression of intimacy between two wearers of paired wearable devices. Either of the wearers may create points of advances in intimacy requiring agreement between the two wearers. The checkpoints may be chosen to be similar to the checkpoints as shown in FIGS. 1A-1G, or may be defined differently by the wearer. The number of checkpoints requiring a mutual agreement may be more numerous 1210 in a first meeting, as shown in FIG. 12A. As the two wearers meet again or repeatedly, the number of checkpoints may be decreased 1220, requiring agreement only at certain increased levels of intimacy, as shown in FIG. 12A. As shown in FIG. 12B, a couple 1235 may be able to ascertain that they are in agreement by noting similar colors 1245 on each wearable device of the paired devices. In contrast, if one party is not comfortable with the current activity, the uncomfortable individual may trigger a higher alert color 1255 on her/his wearable device 1200, which may further send a vibrational alarm 1255 to the other paired device 1230.

When a checkpoint is reached, the signals on the wearable devices of each wearer may change from an initial (e.g., low level of alert, such as a green or blue colored signal) color to a second (e.g., middle level of alert, such as a yellow colored signal). Additionally, one of the paired wearers may have a pre-selected point in progression of intimacy that is pre-selected to trigger a checkpoint with a terminally escalated color signal (e.g., such as a red colored signal). Alternatively, one of the paired wearers may tap his/her wearable device to change indicia to a heightened status/color, prompting a check-in with the other person, as shown in FIG. 12C. The indicia may further include a vibrational alert 1255 on the paired wearer's device 1210. The opportunity to wordlessly signal miss-matched comfort levels and thereby prompt a discussion may advantageously create a pause for distinct conversation about proposed actions, as shown in FIG. 12D and avert a situation where one person in a couple is uncomfortable but feels inhibited from speaking up. The agreement to wear the wearable devices may be a visible signaling device that a wearer has agreed to share the responsibility to ensure both parties are in agreement for intimate activities together.

Passing a checkpoint may include active pairing gestures, which may be any of the gestures described above and illustrated in FIGS. 7A-7D and 8, which confirms that each of the two wearers are in agreement about their intimacy level.

Additional aspects to the use of this system and methods include opportunity/encouragement to capture immediate moments of sharing for recall and/or sharing. As shown in FIGS. 13A-13C, the associated mobile/web-based application may present easily tagged digital “moments” which can be retained, shared with the other individual in the paired engagement, or may additionally be shared with others. Photographs or video may be saved and paired with a fragment of music or other audio effect. The photographs/videos may be saved with a tagline appropriate to the moment. The photographs/videos may be saved with a geo-location and a time stamp. The groups of moments can be saved in a digital scrapbook on the wearer's associated cellphone.

Methods. Various methods are described for use within the system, using any wearable device as described herein, but the invention is not limited to these specific methods.

A method for blood alcohol content (BAC) monitoring is described herein, where the method includes analyzing a BAC level of an individual; and alerting the individual in real time when a pre-selected threshold of the BAC level is reached. Analyzing the BAC level may be performed passively. Analyzing the BAC level may performed continuously or may be performed intermittently. The BAC may be analyzed in real time. The analysis of the BAC level may be performed transdermally. The transdermal analyzing of the BAC level may be performed in the region of a wrist, an ear, a leg, a neck, or an arm of the individual.

Alerting the individual of the BAC level may be performed passively. Alerting the individual may include illuminating a visible signal of a display of a wearable device of the individual. In some variations, the wearable device of the individual may receive information about the BAC level electronically. Alerting the individual may include sending a message to an associated mobile phone of the individual. Sending the message to the associated mobile phone of the individual may include at least one of a BAC level, a graphic of BAC level over time, a warning to slow or stop alcohol composition, a warning of impaired operation of a motor vehicle, or a warning of legal incapacity of consent. Sending a message to the individual may further include at least one of a link to a ride service or a link to emergency personnel. Alerting the individual may include at least one of vibrating a wearable device of the individual or causing a vibration on an associated mobile phone of the individual.

In some variations, alerting the individual may further include alerting a pre-selected second person. The pre-selected second person may be alerted passively, e.g., the individual does not need to actively alert the pre-selected second person. The pre-selected second person may be alerted in substantially real time relative to analyzing the BAC of the individual and/or alerting the individual. Alerting the pre-selected second person may include at least one of texting, sending an email or causing a vibration of a mobile phone of the second person. Texting or sending an email to the second person may include information of at least one of a location of the individual or a BAC level of the individual.

In some variations, alerting the individual may further include alerting a person wearing a second wearable device. Alerting the person wearing the second wearable device may be performed substantially in real time. The second wearable device of the person may receive information about the BAC level of the individual electronically. In some variations, the information about the BAC level of the individual may include a notification of lack of cognitive ability to consent. Alerting the person wearing the second wearable device may include causing the second wearable device to vibrate. Alerting the person wearing the second wearable device may be performed passively.

In some variations, the method including analyzing and alerting may be performed automatically. In some variations, the automatic method including analyzing and alerting may be performed by a computer, and further, optionally, the computer may include non-transitory instructions to perform the method.

A method for pairing a first wearable device of a first wearer and a second wearable device of a second wearer is described herein, wherein the method includes bringing the first and the second wearable device into a proximal location to each other, and exchanging electronic signals between the first and the second wearable device thereby pairing the first wearable device with the second wearable device. In some variations, exchanging electronic signals may be performed passively. In some variations, bringing the first and second wearable device into a proximal location to each other may include touching the first and the second wearable device to each other. In some variations, bringing the first and second wearable device into the proximal location to each other may include bringing the first and second wearable device into a pre-defined orientation with each other. Bringing the first and second wearable device into the proximal location may include maintaining the first and the second wearable device in the proximal location for a pre-defined period of time. The pre-defined period of time may be a period of time of about 2 sec to about 5 sec.

Exchanging electronic signals between the first and second wearable device may further include exchanging personal identifying information.

In some embodiments, the method may further include sending an alert from the first wearable device to the second wearable device. Sending the alert comprises sending information about a Blood Alcohol Content (BAC) level of the first wearer. Sending the alert may occur substantially in real time. Sending the alert may be performed passively. In some variations, sending the alert from the first wearable device to the second wearable device may include causing vibration of the second wearable device. In some variations, sending the alert may include sending a warning of a lack of cognitive ability of the first wearer for consent.

In some variations, sending the alert may be performed actively by the first wearer. In some variations, the method may further include actively unpairing the first wearable device of the first wearer from the second wearable device of the second wearer. Actively unpairing may include performing an unpairing gesture by the first wearer, where performing the unpairing gesture includes sending an electronic signal to the second wearable device, thereby disconnecting the second wearable device from the first wearable device.

In some variations, disconnecting the second wearable device from the first wearable device further may include deleting personal identifying information sent between the first and the second wearable device.

In some variations, the method for pairing a first wearable device of a first wearer and a second wearable device of a second wearer may be performed automatically. In some variations, the method for pairing a first wearable device of a first wearer and a second wearable device of a second wearer may be performed by a computer, and further, optionally, the computer may include non-transitory instructions to perform the method.

Personal wellbeing goals and updates. In another aspect, the system including a wearable device and mobile/web based application may be used to promote personal wellbeing. As shown in FIG. 14, the wearer 1403 may enter personal wellbeing goals or checkpoints on the associated mobile or web-based application for daily use. The wellbeing goals or checkpoints may include, but are not limited to, specific stress reductions activities such as scheduling and taking daily walks 1405; attending yoga or dance classes; or performing stress reduction exercises, including but not limited to breathing or visualization exercises. The personal wellbeing goals may include self-assessment check lists, for which the user (e.g., wearer) may schedule a pre-selected periodicity to track their state of wellbeing. The wearer 1403 may tap 1415 their wearable device 1400 to obtain an update 1407 on their wellbeing goals, which may be presented on the associated mobile phone 1420.

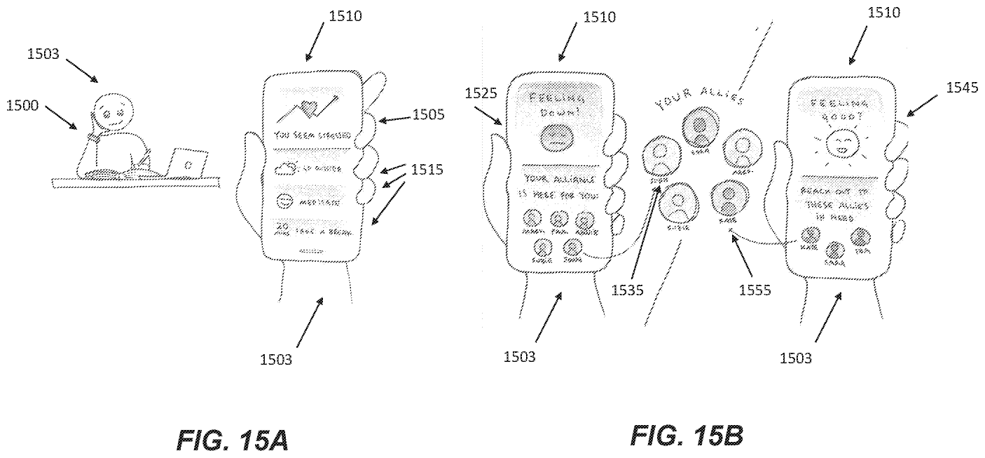

In FIGS. 15A-15B, the system and wearable device 1500 may be used to support the wearer 1503 during periods of stress or depression. The wearer 1503 may enter self-assessment values, which may be interpreted by the processor of the communications hub indicating that the wearer 1503 is stressed or depressed. The wearer 1503 may input the gesture requesting a status update on the wearable device 1500. The communications hub may send an update 1505 to the associated mobile 1510 of the wearer, and may further send some suggestions or tips 1515 to remind the wearer 1503 of potentially helpful interventions, such as, but not limited to: a reminder to go outside and take a walk, a suggestion to meditate to calm the wearer 1503, and/or suggestion to just take a break for a specified period of time. A trusted companion network may also render assistance and the associated mobile 1510 may present an alert 1525, reminding the wearer 1503 that s/he may reach out to one of the individuals 1535 in the notification. The trusted companion network for this use may be the same or different group of individuals as the group of individuals who are standing by during social engagements, may be a totally different group of individuals, or have some members in common. For example, a wearer 1503 may have trusted companions Alex or Katie, with whom the wearer 1503 is comfortable calling upon when the wearer goes out to a bar, as shown in FIG. 9E. However, when the wearer is feeling stressed or depressed, there may be other individuals Mark, Suzie, Annie and/or John with whom the wearer is comfortable seeking out when stressed or depressed, and Alex or Katie are not included in this trusted companion network. The wearer 1503 may reach out to some individuals 1535, when the wearer 1503 is in need of support, and inversely, the wearer 1503 may receive a notification 1545, which points out that the wearer 1503 is in a good mood, and that other members of his trusted companion network for this aspect of engagement, are not doing well. The notification may include a suggestion to reach out to trusted companions Sara and Kate 1555 whose status indicates that each of them are not doing well and could use some support. The real-time interactive nature of the system, in combination with the wearable device, can provide peer-to-peer support as needed.

Gamification. To encourage the adoption and engagement with the systems, devices and methods, game elements may be introduced. Points may be awarded for the number of individuals a user adds to his/her trusted companion network, in-situ social network, and the like. Points may be awarded to an individual for responding to alerts sent to her/him as a member of a trusted companion network, either the occasions when alcohol may be a factor or when the alert arises from an individual's self-monitoring and wellbeing efforts. Points may be awarded to members of an in-situ social network for answering an alert of another individual who needs assistance due to intoxication. These are examples only and do not limit other point awards possible within the system and methods. Gamification may include forming commercial alliances for goods or service discounts or redemption from, for example, a ride-sharing service, a yoga studio, a day spa, a gym, a college-associated brand wear store, or the like.

Gamification may also provide a “push” for both individuals in a coupled social interaction to have a wearable device with the associated mobile/web-based application. Further, specific social events may provide a “push” for enrollment/gamification such as dance events, music events, or sporting events such as marathons or other races.

Non-transitory computer-readable medium. In the systems described herein, a non-transitory computer-readable medium in which a program is stored for causing a computer to perform a method for controlling at least one of acceptable interaction levels; a geographic location definition, a BIL limit; a trusted companion network status; and self-awareness monitoring. The computer performed methods are performed in real time, to provide timely feedback and support to the user of the system (e.g., a wearer of the wearable device).

The computer performed method may include pre-selecting BIL limits. The user may further edit the BIL limits to create a notification threshold when a BIL level has passed a legal or safe level for operating a motor vehicle, or at a desired level, e.g., when the individual has a succeeding event for which she/he does not want to experience any aftereffects of the intoxicant.

The computer performed method may include selecting acceptable interaction levels prior to a specific event. The user may set pre-defined limits of interaction levels, or rely upon the method for selection. The method may include selecting one or more individuals to form a trusted companion network. There may be one or more different trusted companion networks, for example, one trusted companion network may be formed and called upon for social events where intoxicants are present, and a different trusted companion network may be formed and called upon in periods of stress and/or depression. The computer performed method may include selecting a specific geographic location or a defined area around a specific geographic location, which may further be based on a geographic location of the user. The method may further include receiving data from a processor of the wearable device, and sending a notification to a third party.

The computer performed method may include notifying a second individual of the selected geographic location or defined area thereof. The second individual may be a member of a trusted companion network or may be an emergency contact designated by the user. The method may include selecting members of a trusted companion network and permitting notifications to/from the selected members during a pre-selected period of time.

The computer performed method may further include detecting a pairing signal from a second wearable device of a second individual. The method may further include pairing the wearable device with the second wearable device to form a paired interaction. In some variations, the method may further include receiving personal identifying information upon pairing.

The computer performed method may further include initiating a BIL notification indicating the BIL of the wearer. The BIL notification may include a change in the color of the display of the wearable device, a vibrational alert of the wearable device, a vibrational alert of the associated mobile phone and/or a text alert to the associated mobile phone of the user. In some variations, the method may further include sending an alert to selected members of a trusted companion network. The alert may include a vibrational alert, a text alert or both.

In some variations, the computer performed method may further include sending an alert indicating the BIL of the wearer to a paired second wearable device of a second individual. In some variations, the method may further include unpairing from a paired second wearable device.

In some variations, the computer performed method may further include detecting an acknowledgement signal from one or more other wearable devices of one or more other individuals. The acknowledgement signal may indicate a desire to form an in-situ social network. In some variations, the method may further include joining an in-situ social network with individuals wear the respective one or more other wearable devices.

In some variations, the computer performed method may further include inputting self-awareness goals and self-scoring markers. The method may further include delivering stress reduction messages when negative self-scoring markers are inputted. In some variations, the method may include delivering congratulatory messages when positive self-scoring markers are inputted over a period of time. The computer performed method may include inputting one or more individuals to receive notifications of the self-scoring markers. In some variations, the method may include sending notifications to and/or receiving notifications from one or more individuals requesting support.

In some variations, the computer performed method may further include receiving data from a user input interface on the communications hub to save a geographic location associated with a time stamp. The method may further include annotating the geographic location associated with the time stamp with text and/or a photograph.

Although various illustrative embodiments are described above, any of a number of changes may be made to various embodiments without departing from the scope of the invention as described by the claims. For example, the order in which various described method steps are performed may often be changed in alternative embodiments, and in other alternative embodiments one or more method steps may be skipped altogether. Optional features of various device and system embodiments may be included in some embodiments and not in others. Therefore, the foregoing description is provided primarily for exemplary purposes and should not be interpreted to limit the scope of the invention as it is set forth in the claims.

The examples and illustrations included herein show, by way of illustration and not of limitation, specific embodiments in which the subject matter may be practiced. As mentioned, other embodiments may be utilized and derived there from, such that structural and logical substitutions and changes may be made without departing from the scope of this disclosure. Such embodiments of the inventive subject matter may be referred to herein individually or collectively by the term “invention” merely for convenience and without intending to voluntarily limit the scope of this application to any single invention or inventive concept, if more than one is, in fact, disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

1-77. (canceled)

78. A system, comprising:
a wearable device, the device comprising:
a blood intoxicant level (BIL) sensor;
an attaching linker, wherein the attaching linker secures the BIL sensor in proximity to a region of skin of a user for sensing the BIL; and
a communications hub configured to send/receive information to and from the wearable device; and
a non-transitory computer-readable medium in which a program is stored for causing a processor to perform a method comprising:
receiving, from the user, a plurality of contacts, wherein each contact corresponds to a trusted individual;
forming one or more sets of contacts from the plurality of contacts;
identifying a contact set from the one or more sets of contacts;
triggering a first user alert in the wearable device when data received by the BIL sensor indicates that the user has passed a first intoxicant threshold; and
transmitting a trusted individual alert and a second user alert when the data received by the BIL sensor indicates that the user has passed a second intoxicant threshold, wherein the trusted individual alert is transmitted to all of the trusted individuals in the selected contact set, further wherein the trusted individual alert comprises an indication that the user has exceeded the second intoxicant threshold and a location of the user; and wherein the second user alert is a persistent indicator on the wearable device.

79. The system of claim 78, wherein the non-transitory computer-readable medium is configured to confirm with each trusted individual in the selected contact set that they agree to monitor the user for a first period of time.

80. The system of claim 78, wherein the non-transitory computer-readable medium is configured to select the contact set prior to engaging in an activity.

81. The system of claim 78, wherein the non-transitory computer-readable medium is configured to continuously monitor the BIL sensor and to determine a level of intoxicant in the user's body.

82. The system of claim 78, wherein the non-transitory computer-readable medium is configured to received, from the user, an adjustment to one or more of a first intoxicant threshold and a second intoxicant threshold.

83. The system of claim 82, wherein the first intoxicant threshold may only be adjusted down from a first level and the second intoxicant threshold may only be adjusted down from a second level.

84. The system of claim 78, wherein the first user alert comprises a visual indicator comprising a first light display.

85. The system of claim 78, wherein the first user alert comprises a vibration of the wearable device.

86. The system of claim 78, wherein the first user alert is configured to continue until a dismiss command is received from the user.

87. The system of claim 78, wherein the second user alert comprises a visual indicator comprising a second light display.

88. The system of claim 78, wherein the BIL sensor detects blood alcohol level.

89. The system of claim 78, wherein the BIL sensor detects cannabinoid intoxicant level or incapacitating drug level.

90. The system of claim 78, wherein the BIL sensor is a transdermal sensor.

91. The system of claim 78, wherein the attaching linker attaches the BIL sensor in proximity to skin at a region of a wrist, a neck, a finger, an ear, an arm or a leg.

92. The system of claim 78, wherein the attaching linker is a wristband.

93. The system of claim 78, wherein the communications hub comprises one or more of: a display and a vibrational motor.

94. The system of claim 78, wherein the first user alert and the second user alert comprises a set of signals, each having a spectrally distinct wavelength from about 450 nm to about 700 nm.

95. The system of claim 78, wherein the communications hub comprises a sensor for a pairing signal from a second wearable device.

96. The system of claim 78, wherein the communications hub comprises a processor, which is configured to do one or more of: send/receive information to/from the BIL sensor; initiate the at least one visible signal; and/or activate a vibrational motor.

97. The system of claim 78, wherein the communications hub comprises a user input interface comprising one of: a toggle to a preferred mode of “OK” signal; a toggle to an “uncomfortable”/“no consent” mode; an initiation of a message to a third party; and a memory tag.
